(19) United States
(12) Patent Application Publication
(10) Pub. No.: US 2026/0288837 A1
(43) Pub. Date: Sep. 24, 2026

(54) SYSTEM

(71) Applicant: SoftBank Group Corp., Tokyo (JP)

(72) Inventor: Keito ISHIHARA, Tokyo (JP)

(73) Assignee: SoftBank Group Corp., Tokyo (JP)

(21) Appl. No.: 19/564,256

(22) Filed: Mar. 12, 2026

(30) Foreign Application Priority Data
Mar. 19, 2025 (JP) 2025-044896

(51) Int. Cl. G06F 16/335; G06F 16/35

(52) U.S. Cl. CPC G06F 16/335; G06F 16/35

(57) ABSTRACT

A system includes a processor that is configured to receive news information as input, analyze the received news information and, using a generative artificial intelligence model, extract important content based on characteristics of a user, and provide a prompt to the generative artificial intelligence model, the prompt instructing the generative artificial intelligence model to generate news information for reconstructing the extracted content in an expression corresponding to the characteristics and an emotional state of the user.

### CROSS-REFERENCE TO RELATED APPLICATION

This application is based on and claims priority under 35 USC 119 from Japanese Patent Application No. 2025-044896 filed on Mar. 19, 2025, the disclosure of which is incorporated by reference herein.

### BACKGROUND

### Technical Field

The present disclosure relates to a system.

Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional news delivery systems, news information is generally provided in a uniform format that does not sufficiently take into account individual user characteristics, such as a user's expertise, interests, or level of understanding. As a result, users may receive news content that is either too technical, too simplified, or otherwise misaligned with their needs, thereby reducing comprehension and engagement. Furthermore, such conventional systems typically do not consider the emotional state of the user when presenting news information. When emotionally sensitive or stressful news is delivered without adjustment of tone or expression, the content may cause unnecessary anxiety, discomfort, or disengagement. Even when generative artificial intelligence models are used, existing approaches often fail to systematically control prompts and generated outputs in a manner that reflects both user characteristics and the user's current emotional state. Accordingly, there is a need for a system that can dynamically analyze news information, extract important content with the aid of a generative artificial intelligence model, and reconstruct the content in expressions tailored to both the characteristics and emotional state of the user, thereby improving personalization, comprehension, and emotional suitability of news delivery.

### SUMMARY

To solve the above-described problems, a system according to one embodiment of the present invention comprises a processor configured to receive news information as input and analyze the received news information. The processor is configured to use a generative artificial intelligence model to extract important content based on characteristics of a user, such as the user's background, expertise, interests, or preferred level of detail. The processor is further configured to provide a prompt to the generative artificial intelligence model, the prompt instructing the generative artificial intelligence model to generate news information for reconstructing the extracted content in an expression corresponding to both the characteristics and an emotional state of the user. In particular, the processor is configured to analyze the emotional state of the user and adjust a tone of the generated news information based on the emotional state, thereby enabling, for example, a softer, more reassuring tone when the user is under stress, or a neutral and concise tone when the user is calm or in a professional context. The processor is also configured to output the reconstructed and tone-adjusted news information to a user terminal or other output interface. Through these means, the system enables adaptive generation and delivery of news content that is personalized in substance and expression, and that is appropriately aligned with the user's emotional condition.

The term “system” refers to an arrangement comprising at least one processor and, optionally, one or more memories, communication interfaces, and input/output devices configured to perform the functions described in the claims.

The term “processor” refers to any hardware device or combination of hardware devices, such as a central processing unit (CPU), graphics processing unit (GPU), application-specific integrated circuit (ASIC), or programmable logic device, that is configured to execute instructions and perform the operations recited in the claims.

The term “news information” refers to information relating to current or recent events, topics, or reports, including but not limited to textual articles, summaries, headlines, or other content obtained from news sources or data feeds.

The term “input” refers to data or information that is received by the processor from an external source, such as a server, database, network, or user device, for processing according to the operations described in the claims.

The term “analyze” refers to processing operations performed by the processor to examine, interpret, or transform data, including but not limited to parsing, classifying, scoring, segmenting, or otherwise processing the data to derive information used in subsequent operations.

The term “generative artificial intelligence model” refers to a machine learning model trained to generate new content, such as text, based on input data and prompts, including but not limited to large language models, transformer-based models, or other neural network architectures capable of content generation.

The term “user” refers to a human individual who receives, views, or otherwise consumes the news information generated or processed by the system, and whose characteristics and emotional state are used as a basis for personalization.

The term “characteristics of a user” refers to attributes associated with the user, including but not limited to demographic information, expertise level, interests, preferences, language, or any other profile information used by the processor to tailor news information.

The term “important content” refers to portions of the news information that are determined by the processor, in conjunction with the generative artificial intelligence model, to be relevant or significant for the user based on the user's characteristics.

The term “prompt” refers to data provided to the generative artificial intelligence model by the processor, including instructions, context, constraints, or example text, that guide the generative artificial intelligence model in generating news information according to the requirements of the system.

The term “emotional state” refers to a condition or status of a user's emotions, such as stress, anxiety, calmness, excitement, or other affective states, which is determined or estimated by the processor and used to influence the generation or adjustment of news information.

The term “expression” refers to the manner in which content is presented in generated news information, including word choice, style, level of formality, complexity, and overall presentation adapted to the user's characteristics and emotional state.

The term “tone” refers to an affective or stylistic quality of the generated news information, such as reassuring, neutral, urgent, formal, or casual, which is adjusted by the processor based on the emotional state of the user.

The term “generate news information” refers to an operation in which the generative artificial intelligence model produces new textual content or reformulated content, based on a prompt and the original news information, for delivery to the user.

The term “reconstructed news information” refers to news information that has been generated or reformulated by the generative artificial intelligence model, under control of the processor, so that the content and expression are adapted to the characteristics of the user.

The term “tone-adjusted news information” refers to reconstructed news information whose tone has been modified by the processor, directly or indirectly through the generative artificial intelligence model, in accordance with the emotional state of the user.

The term “output” refers to making data available outside the processor, including transmitting, displaying, storing, or otherwise providing reconstructed and tone-adjusted news information to a terminal, server, or other device accessible to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

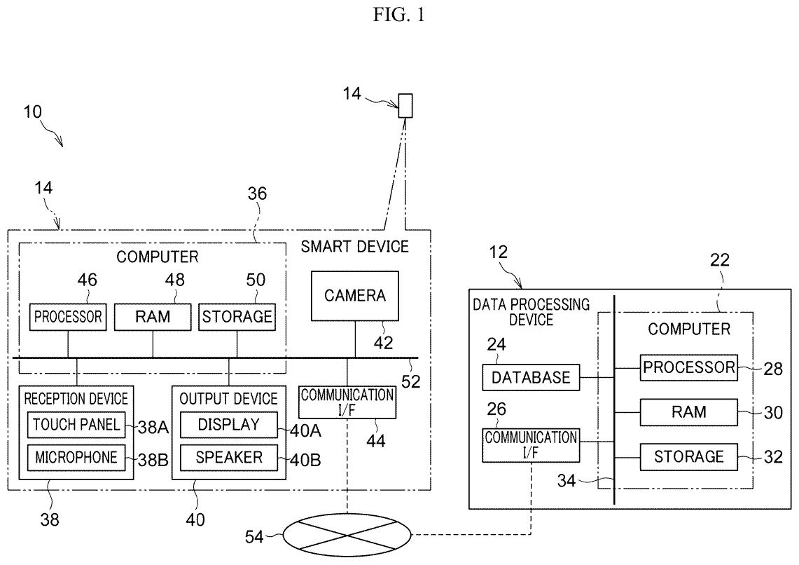

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

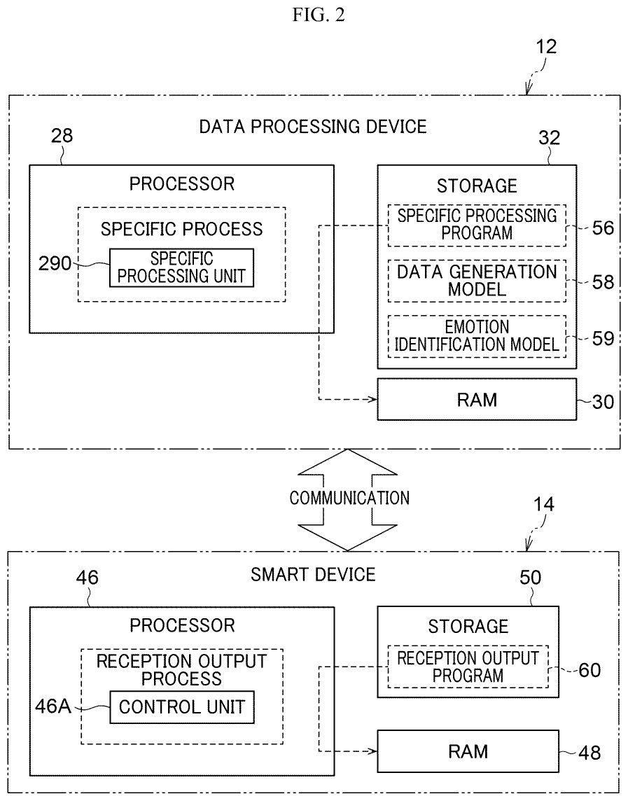

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information delivery systems typically retrieve news articles or other textual content and present them to users with limited adaptation to individual user characteristics or real-time emotional states. In many cases, such systems perform only coarse filtering or simple template-based summarization, which does not fully exploit the structure of the underlying text or the specific cognitive and emotional needs of the user. As a result, users may receive information that is either too superficial, too detailed, or misaligned in tone, thereby degrading user comprehension, engagement, and decision-making efficiency.

Moreover, existing architectures often treat large-scale generative models as black-box components that operate directly on raw text or high-level prompts without systematic preprocessing. This can lead to suboptimal use of computing resources and model capacity, because the generative model must internally perform both low-level linguistic analysis and high-level content reconstruction. This redundant processing increases latency, burdens processor and memory resources, and may yield inconsistent output quality, particularly when handling long or heterogeneous document sets obtained from multiple external sources.

Further, in many current systems, the generation prompt supplied to a generative model is not explicitly structured from machine-extracted key content and user-specific metadata. Instead, prompts are often manually designed or heuristically assembled, resulting in unstable generation behavior. The lack of a defined pipeline for extracting key syntactic units, computing importance scores, and encoding such information into a structured prompt prevents the generative model from being reliably steered toward user-appropriate summaries. Consequently, the overall computer system is not effectively configured to transform heterogeneous network documents into output that is optimized for the user's profile and emotional state.

Additionally, existing solutions insufficiently integrate delivery mechanisms—such as real-time display on user terminals and distribution via electronic mail—with content generation logic. The absence of a unified, processor-level configuration that covers acquisition, analysis, prompt construction, generative model invocation, emotional-state-aware adjustment, and multi-channel output leads to fragmented implementations. This fragmentation complicates system design, reduces scalability, and hampers optimization of throughput and responsiveness at the computer system level.

Accordingly, there is a need for an improved computer-implemented system and method that: (i) acquires document information from external information sources in a structured manner; (ii) applies explicit natural language processing and document summarization algorithms to extract important syntactic units and phrases; (iii) programmatically constructs structured prompt sentences incorporating user characteristic information and extracted context; (iv) controls a generative model based on user characteristics and emotional state to produce summaries with appropriate tone and level of detail; and (v) efficiently outputs the reconstructed information to user terminals through display and electronic messaging. Such a system should improve the functioning of the computer by reducing redundant processing in the generative model, stabilizing generation quality, and enabling scalable, low-latency adaptation of content to user-specific requirements.

The specific processing by the specific processing unit 290 of the data processing device 12 in Example 1 is realized by the following means.

The present invention provides a server comprising a processor configured to acquire identification information of an external information source and user characteristic information, obtain document information via a network based on the identification information, analyze the document information by using a natural language processing program to segment the document information into syntactic units, assign part-of-speech information and phrase information to the syntactic units, calculate importance scores based on degrees of relevance among the syntactic units, extract important syntactic units and phrases, generate a prompt sentence including instruction information that contains the user characteristic information and context information that contains the extracted syntactic units and phrases, provide the prompt sentence to a generative information processing model so as to cause the generative information processing model to generate summary information corresponding to the user characteristic information, adjust, based on user emotional state information and the user characteristic information, at least one of the prompt sentence to be input to the generative information processing model and an expression format of the generated summary information to generate reconstructed information having a tone and a level of detail corresponding to the user emotional state, and output the reconstructed information to a user terminal via at least one of a display device and a message delivery device. This enables an improvement in computer functionality by structuring the processing pipeline so that low-level linguistic analysis and importance scoring are performed prior to generative inference, by supplying the generative model with a machine-constructed, context-rich prompt tailored to user characteristics and emotional state, and by integrating generation, tone adjustment, and multi-channel output control within the processor, thereby reducing redundant processing within the generative model, stabilizing output quality, and enhancing the efficiency and responsiveness of information delivery to the user terminal.

The term “processor” refers to one or more hardware-based information processing units, such as a central processing unit or an execution core, configured to execute instructions and thereby perform the functions described in the present disclosure.

The term “communication unit” refers to a hardware and software combination, such as a network interface and associated communication program, configured to send and receive data over a communication network.

The term “external information source” refers to any information providing entity accessible via a network, including but not limited to servers, data feeds, and content distribution systems that supply document information.

The term “identification information” refers to data used to specify or locate an external information source, such as a uniform resource identifier, a feed identifier, or other source-specifying data.

The term “user characteristic information” refers to information indicating attributes of a user, including at least one of user interests, user industry, user role, user knowledge level, preferred output format, and preferred output length.

The term “document information” refers to text-based content obtained from an external information source, including but not limited to articles, reports, messages, and other machine-readable textual data.

The term “network” refers to a communication infrastructure, including wired or wireless communication links and intermediate devices, configured to enable data transfer between the server and external information sources or user terminals.

The term “natural language processing program” refers to software configured to analyze human-language text, including functions such as segmentation, tokenization, part-of-speech tagging, syntactic parsing, and entity recognition.

The term “syntactic unit” refers to a segment of a text, such as a sentence, clause, or phrase, that is treated as a discrete unit for linguistic analysis.

The term “part-of-speech information” refers to data indicating grammatical categories assigned to tokens in text, such as noun, verb, adjective, adverb, and similar word classes.

The term “phrase information” refers to data indicating phrase-level structures in text, such as noun phrases, verb phrases, and other multi-token groupings.

The term “degree of relevance” refers to a measure indicating a relationship or similarity between syntactic units, which may be computed based on lexical, semantic, or statistical features.

The term “importance score” refers to a numerical or ordinal value assigned to a syntactic unit or phrase that represents the relative importance of the unit or phrase within the document information.

The term “prompt sentence” refers to a machine-generated instruction text provided as input to a generative information processing model, the instruction text specifying at least one of a task description, a desired output style, and user-related constraints.

The term “instruction information” refers to content included in a prompt sentence that directs a generative information processing model how to process input data, including at least one of required tasks, output format, focus topics, and level of detail.

The term “context information” refers to information supplied to a generative information processing model together with instruction information, the context information including at least extracted syntactic units, phrases, and optionally metadata derived from document information.

The term “generative information processing model” refers to a trained computational model, such as a generative artificial intelligence model, configured to generate text or other data outputs based on input prompt information and context information.

The term “summary information” refers to information generated by a generative information processing model that represents a condensed or abstracted form of the document information.

The term “user emotional state information” refers to information indicating a psychological or affective condition of a user, such as stress level, mood, or engagement state, which may be estimated or determined by measurement or inference.

The term “expression format” refers to a style or structural pattern of an output text, including at least one of sentence complexity, tone, vocabulary level, layout, and use of bullet points or paragraphs.

The term “tone” refers to a qualitative characteristic of output text, such as formal, informal, neutral, optimistic, or cautious, that affects how information is conveyed to the user.

The term “level of detail” refers to an extent of granularity in the content of output text, such as the amount of explanation, the number of included facts, and the depth of technical description.

The term “reconstructed information” refers to information generated by the processor based on output from the generative information processing model, adjusted according to user characteristic information and user emotional state information.

The term “user terminal” refers to an information processing device operated by a user, such as a portable communication device, a personal computing device, or a display-equipped appliance, capable of receiving and presenting information.

The term “display device” refers to any hardware capable of visually presenting information to a user, including but not limited to a monitor, a touch screen, or an integrated display panel.

The term “message delivery device” refers to a component or service, including electronic mail systems and messaging systems, configured to transmit messages containing reconstructed information to user terminals.

The term “circulation-type information” refers to information that is periodically or repeatedly distributed over a network, such as syndicated feeds, periodic bulletins, or similar recurring content streams.

The term “standardized description format” refers to a predefined structured data representation used for distributing document information, including but not limited to markup-based formats and feed-based formats.

The term “document summarization algorithm” refers to a computational procedure that, given document information, selects or generates a subset or condensed representation of the document information based on measures of importance or relevance.

The term “electronic mail transmission information” refers to data that defines a message for electronic mail delivery, including at least a destination address, a subject, a body, and optionally formatting and header information.

In one embodiment, a server executes a program that implements the claimed system. The server includes at least one processor, a memory, and a communication unit connected to a communication network. The server cooperates with at least one terminal operated by a user. The terminal includes a display device, an input device, and a communication unit. The user operates the terminal to provide input conditions and to receive reconstructed information generated by the server.

The server stores, in the memory, program modules including an acquisition module, a natural language processing module, an importance scoring module, a prompt generation module, a generative model interface module, an emotional-state adjustment module, and an output control module. The server further stores, in the memory, a user profile data structure and an emotional state data structure for each user, as well as configuration data specifying external information sources.

The server uses the acquisition module to obtain document information from external information sources. The server uses a general-purpose communication stack implemented on an operating system, and an application-level HTTP client library such as an HTTP request library for accessing uniform resource identifiers corresponding to news feeds and article pages. The server accesses circulation-type information, for example information distributed as standardized feeds such as structured markup feeds, and information distributed as structured markup documents such as hierarchical markup language documents. The server parses the obtained raw data using a document parsing library such as a generic markup parser or a feed parser. The server converts the raw markup into an internal normalized document data structure. The server may represent each document as a record containing fields such as a document identifier, source identifier, timestamp, title text, body text, and metadata tags. The server stores these records in a document buffer region of the memory.

The server uses the natural language processing module to analyze the body text of the document records. The server may employ a software library such as a natural language toolkit or a syntactic analysis library. The server loads a language model, for example a pre-trained statistical or neural model for tokenization and part-of-speech tagging, into the memory. The server applies this model to the body text to segment the text into tokens and sentences. The server then assigns part-of-speech tags to each token and optionally derives phrase boundaries using a chunker or dependency parser. The server converts the analysis results into a syntactic-unit data structure. In one example, the server represents each sentence as an object containing a sentence identifier, a list of token objects, part-of-speech tags for each token, phrase labels, and dependency links. The server associates each syntactic-unit object with the corresponding document identifier and stores it in a syntactic-unit store in the memory.

The server uses the importance scoring module to compute an importance score for each syntactic unit. In one embodiment, the server calculates a term-weight matrix for the sentences using a vectorization method such as term frequency-inverse document frequency. The server computes pairwise similarity values between sentences using a similarity metric such as cosine similarity. The server constructs a graph data structure in which each node represents a sentence and each edge weight represents the similarity between sentences. The server then executes a graph-based ranking algorithm such as TextRank or a similar iterative ranking method. The server updates a score for each sentence node according to a recurrence relation, for example a weighted sum of neighboring node scores multiplied by a damping factor. The server iteratively updates the scores until the change in scores is below a threshold or a preset iteration count is reached. The server then assigns the converged scores as importance scores for the corresponding sentences. The server stores the importance scores as attributes in the syntactic-unit data structure.

The server uses the importance scores to select important syntactic units and phrases. For example, the server selects sentences whose importance scores are in a top percentage or above a threshold. The server further extracts keyword candidates by aggregating token frequencies within the selected sentences, removing stop words, and optionally applying a phrase extraction method that considers part-of-speech patterns such as noun phrase patterns. The server stores the extracted keywords and key phrases in a key-context data structure associated with the user and the current document set.

The server uses the user profile data structure to tailor the selection of syntactic units. The user profile may contain attributes such as domain category, role category, knowledge level, topic preferences, and preferred summary length. The server filters candidate sentences using rules based on lexical features and named-entity types. For example, when the user domain category is finance, the server may prioritize sentences that contain monetary values, references to financial institutions, or economic indicators. The server may maintain a domain-specific vocabulary list in the memory and check for the occurrence of domain terms in each candidate sentence. The server thereby narrows down the set of extracted syntactic units to those most relevant to the user characteristics.

The server uses the emotional state data structure to represent the user emotional state information. The server may obtain this information from explicit user input through the terminal, from physiological sensors connected to the terminal, or from analysis of recent user interactions. In one embodiment, the server maintains an emotional state vector with components such as arousal level and valence level, each represented by a numerical value. The server may also store a discrete emotional label such as “stressed,” “calm,” or “uncertain.” The server updates the emotional state vector based on incoming measurements or inferred indicators.

The server uses the prompt generation module to construct a prompt sentence for a generative information processing model. The server composes the prompt from several components: instruction information, user characteristic information, and context information. The server generates the instruction information as a textual directive that specifies the desired task, output format, and level of detail. For example, the server may generate a text such as:

“Summarize the following key points about the latest economic news into a concise report for professionals in the financial industry with advanced knowledge. Focus on central bank decisions, interest rates, and market reactions. Format the output as bullet points.”

The server inserts user characteristic information into the instruction, such as indicating that the target reader works in a specific domain and has a particular knowledge level. The server then appends context information, including the extracted key sentences and keywords, to the instruction text. For example, the server may generate a prompt sentence in the following form:

“User profile: domain=finance, knowledge level=advanced.

Task: Summarize the following key points about the latest economic news into a concise report for professionals in the financial industry. Emphasize central bank policies, interest rate changes, and stock market responses.

Key sentences:
1. [Sentence 1]
2. [Sentence 2]
3. [Sentence 3]
Keywords: [keyword1], [keyword2], [keyword3].”

The server may generate variations of the prompt sentence depending on the user knowledge level. For a beginner-level user, the server may generate a prompt such as:

“Summarize the following key points about recent economic news in a way that is easy for a beginner to understand. Avoid technical jargon and explain important terms. Limit the summary to about 300 words.”

The server uses the emotional-state adjustment module to modify the instruction portion or to specify a desired tone parameter for the generative model output. For example, when the emotional state vector indicates high stress and low valence, the server may add instructions such as “Use a calm and reassuring tone, and avoid alarmist language.” When the user is a high-expertise professional under time pressure, the server may add instructions such as “Use a concise, technical tone without introductory explanations.”

The server uses the generative model interface module to interact with a generative information processing model. In one embodiment, the server accesses a neural network-based generative language model hosted as a separate service. The generative model may have a transformer architecture including multiple attention layers, feed-forward layers, and normalization layers. The model parameters are stored on a separate computing resource such as a graphics processing unit or a specialized accelerator. The generative model is trained in advance on large-scale text data using a learning algorithm that minimizes a loss function, such as a cross-entropy loss between predicted token probabilities and actual tokens in training sequences, using weight update procedures such as stochastic gradient descent or its variants including adaptive optimization methods. During training, the model may use data augmentation strategies such as text corruption or masked token prediction to improve generalization.

The server formats the prompt sentence and context into a request message compatible with the generative model service. The server sends the request through the communication unit using a network protocol such as hypertext transfer protocol over a secure channel. The request message includes the textual prompt, a maximum token length parameter, a sampling temperature parameter, and optionally a tone control parameter inferred from the user emotional state. The generative model receives the prompt tokens, applies the transformer layers to compute attention-weighted representations, and generates output tokens by sequential sampling according to the computed probability distribution. The generative model returns the generated token sequence to the server.

The server receives the generated token sequence and converts it into text. The server may perform post-processing such as truncating the text to satisfy a maximum length specified by the user profile, ensuring that the output contains required sections, and removing extraneous fragments. The server then treats the resulting text as reconstructed information. The server stores the reconstructed information in an output buffer associated with the user.

The server uses the output control module to deliver the reconstructed information to the terminal. When the user has selected display on the terminal, the server generates a structured response message, such as a markup document, that includes headings, bullet points, and links to original documents. The server sends this markup document to the terminal over the network. The terminal receives the markup document using its communication unit and renders the content on the display device using a browser engine or a native application. When the user has selected electronic mail delivery, the server uses a mail transmission library to construct an electronic mail message that includes the reconstructed information in the message body. The server sets the destination address based on the user profile and transmits the electronic mail through a mail transfer protocol server. The terminal later retrieves the electronic mail using a mail client and displays the reconstructed information to the user.

The server improves computer technology by splitting processing responsibilities between pre-processing modules and the generative model in a non-conventional manner. The server performs deterministic syntactic analysis, importance scoring, and domain-specific filtering before invoking the generative model. As a result, the generative model receives a compressed, information-dense context rather than raw document information. This reduces the number of tokens processed by the generative model, lowers computational load on the model hardware, and shortens response time. Because the server supplies structured, high-salience context and explicit user and emotional-state constraints in the prompt sentence, the generative model can generate output with more stable quality and reduced variance in style. The server thereby reduces the need for repeated regeneration and re-ranking, which further decreases processing time and network traffic.

The server uses specific data structures, such as the syntactic-unit graph with importance scores and the emotional state vector, which are not present in conventional systems that merely forward raw text to a generative model. The server's use of a graph-based ranking algorithm for sentences and a rule-based domain filter tuned to user characteristics ensures that only context relevant to the user is input to the generative model. This targeted context reduces noise in the model input, leading to improved accuracy of the generated summary relative to the user's needs. The server thus improves both speed and accuracy of content generation.

The server employs non-traditional rules for emotional-state adjustment. Rather than simply changing template phrases, the server modifies prompt-level constraints and, in some embodiments, specifies tone control parameters that affect the generative model's token sampling behavior. For example, the server may adjust the sampling temperature parameter to produce less extreme language when the user is stressed, or include explicit directives to avoid certain categories of expressions. These algorithmic modifications are applied automatically by the server based on numerical emotional state vectors, and they result in measurable changes in lexical choice and sentence structure. This constitutes a technical control of model behavior that goes beyond manual tone editing by a human.

The server can be configured in alternative embodiments. In one variation, the server runs the generative information processing model locally instead of accessing an external service. In this case, the server loads a transformer-based language model from local storage into a memory region accessible by a graphics processing unit. The server uses a model inference engine that schedules parallel matrix operations and attention computations. The server passes tokenized prompt sequences through multiple model layers, where each layer performs linear transformations, attention-weighted aggregation, and non-linear activation. The server then obtains output token logits, applies a softmax function to compute probabilities, and samples output tokens. The server may adjust model hyperparameters such as the number of decoding beams or the top-k sampling parameter based on user profile and emotional state. This local-inference embodiment further reduces network latency and allows more fine-grained control over internal model behavior.

In another variation, the server uses different document summarization algorithms in the importance scoring module, such as centroid-based summarization or supervised sentence scoring models trained on labeled summary datasets. The server may store additional feature vectors for each sentence, including semantic embeddings computed by a sentence encoder. The server may then compute importance scores using a learned function of these features. Such alternative scoring methods can further improve the precision of key-sentence selection, which in turn enhances the relevance of the context fed to the generative model.

In yet another embodiment, the server maintains multiple user profiles for different usage modes, such as a “brief mode” and a “detailed mode.” The server switches among these profiles depending on the user's recent interaction history or explicit mode selection on the terminal. The server then modifies the prompt sentence and filtering thresholds accordingly. This allows the same underlying system to support various technical requirements, such as delivering short notifications on a mobile device or delivering detailed reports on a desktop terminal, while reusing the same foundational data structures and generative control mechanisms.

The terminal cooperates with the server by providing user input and presenting outputs. The user uses the terminal to input initial requirements in free text or by selecting options through a graphical user interface. For example, the user may input a text such as “Get the latest economic news and summarize it for the financial industry, then send the result by email.” The terminal transmits this input to the server as part of a request. The server parses the input and incorporates the user's wording into the instruction portion of the prompt sentence. In this way, the system supports user-level customization while still maintaining a structured internal representation that enables efficient and precise control of the generative model.

The described embodiments focus on internal computer-implemented processing rather than a mere automation of human summarization. The server employs specific data structures, algorithms, and parameterized control of a neural network model to achieve technical effects such as reduced computational load, faster response, improved output stability, and more efficient network usage. These improvements arise from particular interactions between the acquisition module, the natural language processing module, the importance scoring module, the prompt generation module, the emotional-state adjustment module, and the generative model interface module, as executed by the server's processor and supported by the memory and communication unit.

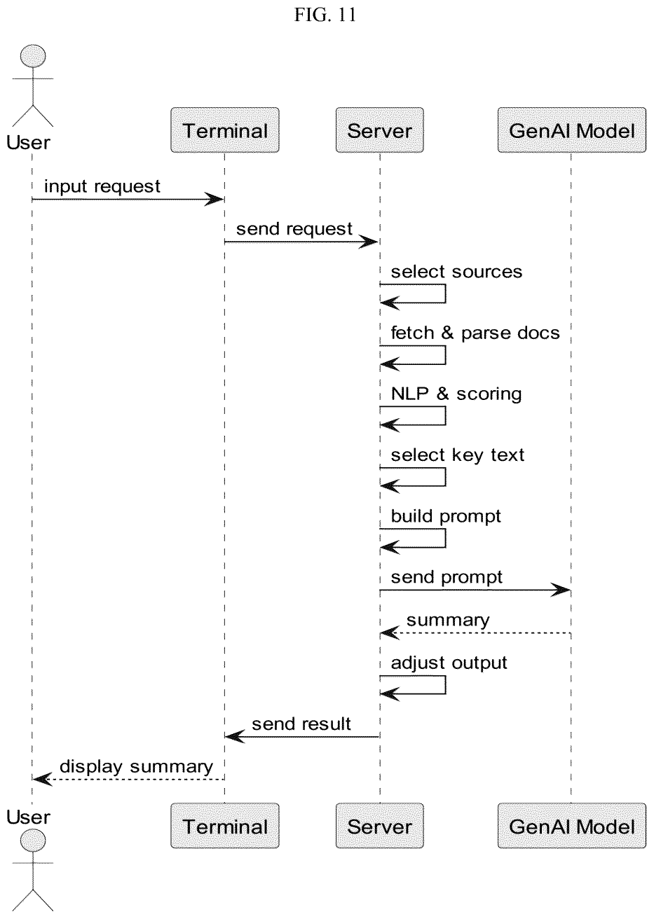

The following describes the processing flow using FIG. 11.

### Step 1

The user operates the terminal to input request conditions and preferences. The user provides, as input, information such as a desired topic (for example, economic news), a target domain (for example, financial industry), a preferred delivery method (for example, display or email), and a preferred level of detail. The terminal converts these user inputs into a structured request message including user identifiers and sends the message to the server via a communication network. The output of this step is a request message received by the server that contains user requirement information and user identification information.

### Step 2

The server receives the request message from the terminal through a communication unit. The server parses, as input, the structured request message to extract user identifiers, topic information, domain information, preferred delivery method, and level-of-detail settings. The server then accesses a user profile storage in a memory to retrieve user characteristic information corresponding to the user identifiers, including domain category, role category, knowledge level, and registered contact information. The server combines the extracted requirement information with the stored user characteristic information to form a unified user context record. The output of this step is the user context record stored in the memory.

### Step 3

The server determines external information sources based on the user context record. The server uses, as input, the topic and domain information within the user context and a configuration table that maps topics and domains to source identifiers and network locations. The server selects a set of external information source identifiers and corresponding network addresses, such as feed URLs and document URLs. The server constructs a source list data structure that includes each selected network address and associated source metadata. The output of this step is the source list data structure stored in the memory.

### Step 4

The server acquires document information from the external information sources. The server uses, as input, the source list and employs an HTTP client library over the communication unit to send retrieval requests to each network address. The server receives markup-based documents as responses, such as structured feeds and markup language pages, and records response metadata including timestamps and status codes. The server parses the received data using a markup parser and a feed parser to extract document titles, body texts, timestamps, and tags. The server converts the extracted elements into normalized document records, each containing a document identifier, source identifier, title field, body field, and metadata fields. The output of this step is a collection of normalized document records stored in a document buffer in the memory.

### Step 5

The server preprocesses the body text of the document records. The server uses, as input, the normalized document records and applies text-cleaning operations such as removal of markup tags, scripts, style elements, and boilerplate phrases. The server normalizes character encodings to a unified encoding, standardizes whitespace, and removes control characters. The server writes the cleaned text back into the body fields of the corresponding document records. The output of this step is a set of cleaned document records with normalized textual content stored in the memory.

### Step 6

The server performs linguistic analysis of the cleaned document text. The server uses, as input, the cleaned document records and loads a natural language processing program and associated language models into the memory. The server segments each document body into sentences and then into tokens. The server assigns part-of-speech tags to each token and determines phrase boundaries or syntactic dependencies. The server constructs syntactic-unit objects for each sentence, each object containing token sequences, part-of-speech information, phrase labels, and dependency information linked to the source document identifier. The output of this step is a syntactic-unit store that holds syntactic-unit objects associated with the document records.

### Step 7

The server computes importance scores for the syntactic units. The server uses, as input, the syntactic-unit store and constructs, for each document, a vector representation of sentences using term-weighting such as term frequency-inverse document frequency. The server computes pairwise similarity values between sentence vectors and stores them in a similarity matrix. The server builds a graph structure where nodes correspond to sentences and edge weights correspond to similarity values. The server executes an iterative ranking algorithm over the graph, updating sentence scores based on weighted contributions from neighboring sentences until a convergence condition is met. The server assigns the converged scores as importance scores for each sentence and stores these scores as attributes in the syntactic-unit objects. The output of this step is an updated syntactic-unit store with assigned importance scores.

### Step 8

The server selects key syntactic units and extracts keywords. The server uses, as input, the syntactic-unit store with importance scores and applies a selection rule, such as selecting sentences whose importance scores exceed a threshold or belong to a top-rank subset. The server further analyzes the selected sentences to compute token frequency statistics, remove stop words, and identify multi-token phrases according to part-of-speech patterns. The server creates a key-context record that includes selected sentences, key phrases, and associated document identifiers. The output of this step is the key-context record stored in the memory.

### Step 9

The server filters the key-context record based on user characteristic information. The server uses, as input, the key-context record and the user context record. The server compares tokens and named entities in the selected sentences with domain-specific vocabulary lists and interest tags stored for the user. The server removes sentences and phrases that do not match the user's domain, topics, or knowledge level. The server adjusts the number of retained sentences to match the user's preferred summary length. The server constructs a user-tailored key-context record that contains only the filtered sentences and phrases. The output of this step is the user-tailored key-context record stored in the memory.

### Step 10

The server determines user emotional state information. The server uses, as input, the user context record and any newly received emotional indicators, such as user-provided mood labels, sensor data transmitted from the terminal, or recent interaction metrics. The server updates an emotional state vector and an emotional label field within an emotional state record associated with the user. The server may normalize or smooth the emotional state values over time. The output of this step is an updated emotional state record stored in the memory.

### Step 11

The server generates a prompt sentence for a generative AI model. The server uses, as input, the user-tailored key-context record, the user context record, and the emotional state record. The server composes instruction text specifying the task, output format, and detail level, embedding user characteristics such as domain and knowledge level. The server adds constraints corresponding to the emotional state, such as specifying a calm, neutral, or technical tone. The server then appends the filtered key sentences and keywords to form a complete prompt text. For example, the server may generate prompt text such as:

“Summarize the following key points about the latest economic news into a concise report for professionals in the financial industry with advanced knowledge. Focus on central bank decisions, interest rates, and market reactions. Use a calm and objective tone.

Key sentences:
1. . . .
2. . . .
3. . . .
Keywords: . . . ”

The server stores the resulting prompt text in a prompt data structure. The output of this step is the prompt data structure containing the prompt sentence and associated metadata.

### Step 12

The server invokes the generative AI model using the generated prompt sentence. The server uses, as input, the prompt data structure and generative model configuration parameters such as maximum output length, sampling temperature, and decoding strategy. The server formats the prompt and parameters into a request message conforming to a model interface specification and transmits the request to a generative language model, either via a network to a model service or via a local model inference engine. The generative model processes the prompt and produces a sequence of output tokens representing summary information. The server receives the output tokens, reconstructs them into text, and stores the generated summary text in a reconstructed-content record. The output of this step is the reconstructed-content record containing the generated summary information.

### Step 13

The server adjusts the reconstructed-content record based on user emotional state information and presentation requirements. The server uses, as input, the reconstructed-content record, the user context record, and the emotional state record. The server analyzes the generated text to check length, section structure, and presence of required focus topics. The server may truncate or reorder sections to satisfy the user's preferred level of detail and structure. The server may also apply tone-consistency checks and, if necessary, append or modify certain phrases to align more closely with the emotional-state constraints. The server produces a finalized reconstructed information text suitable for delivery. The output of this step is a finalized reconstructed-information record stored in the memory.

### Step 14

The server outputs the finalized reconstructed information to the terminal. The server uses, as input, the finalized reconstructed-information record and the preferred delivery method in the user context record. When the delivery method is display, the server generates a response message such as a markup document containing the reconstructed text, headings, and optional links, and sends this message to the terminal via the communication unit. When the delivery method is electronic mail, the server constructs an email message including the reconstructed text in the body, sets the recipient address from the user profile, and transmits the email through a mail transfer system. The output of this step is either a response message received and rendered by the terminal or an electronic mail message delivered to the user's mailbox.

### Step 15

The terminal receives the reconstructed information from the server. The terminal uses, as input, either the response message from the server or an electronic mail message retrieved from a mail server. The terminal decodes and parses the received data, renders the reconstructed text on the display device using a browser engine or email client, and presents the information to the user. The output of this step is a visual presentation of the reconstructed information on the terminal display, enabling the user to view the summary generated by the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional news distribution systems typically deliver generic article lists that are only coarsely filtered by topic or source, and rely on fixed, rule-based personalization logic. Such systems often process text by simple keyword matching or static templates and do not fully exploit advanced natural language processing and generative modeling capabilities. As a result, these systems are unable to adapt the linguistic difficulty, length, and focus of presented news content to individual user attributes such as specific interest fields, knowledge levels, and reading abilities. This leads to information overload, inefficient consumption of digital resources, and suboptimal utilization of computing infrastructure, because users must manually search and reinterpret large volumes of unstructured text to obtain content that is actually relevant and comprehensible to them.

Furthermore, in typical architectures, user interaction data such as click history or explicit evaluations are only used to adjust ranking scores of articles in a coarse manner. Conventional systems do not tightly integrate this feedback into a unified computational pipeline that governs not only which articles are selected, but also how prompts for a generative model are constructed and how the generated outputs are formatted. In particular, existing solutions do not systematically encode user attributes and feedback into prompt sentences that drive a generative AI model to produce summaries or rewrites that are computationally optimized for the user's profile. Consequently, the processing pipeline does not efficiently transform raw article data into individualized content, and the underlying processors, memory, and network resources are not leveraged to achieve improved throughput, latency, and relevance in personalized content delivery.

In addition, known systems generally treat generative models as isolated components, invoked with manually crafted or static prompts. Such an approach prevents dynamic, programmatic control over the generative process and fails to exploit feedback loops in which prompt structures and content are continuously refined based on updated user attributes. This limits the ability of the computing system to converge toward more accurate personalization and causes redundant computations, including generation of unnecessarily long or inappropriate outputs that must be discarded or manually filtered.

Therefore, there is a need for an improved computer-implemented system and method that (i) automatically acquires article information from network resources, (ii) performs structured natural language analysis on the acquired information, (iii) maintains and updates detailed user attribute information based on interaction history, (iv) programmatically generates prompt sentences for a generative AI model based on both article analysis results and user attributes, and (v) produces and delivers individualized content in a way that improves the efficiency, accuracy, and technical performance of the overall information processing pipeline. Such a system should reconfigure the operation of the processor and memory to achieve more effective use of computational resources when generating and distributing personalized news content.

The specific processing by the specific processing unit 290 of the data processing device 12 in Application Example 1 is realized by the following means.

The present invention provides a server comprising a processor configured to obtain article information from network resources and store the article information as structured character information in a storage medium; perform natural language processing on the stored article information to generate analysis information including phrase information, importance information, and event information; maintain user attribute information including interest information, knowledge level information, and reading ability information, and select, on the basis of the analysis information and the user attribute information, article information related to a user while performing weighting processing and ranking processing on the selected article information; generate, on the basis of the analysis information and the user attribute information, a prompt sentence to be input to a generative information processing model, provide the prompt sentence to the generative information processing model, and cause the generative information processing model to generate summary information or rewritten information of the article information; associate the summary information or the rewritten information acquired from the generative information processing model with identification information and supplementary information of the corresponding article information to generate individualized information; transmit the individualized information to a user terminal; and update the user attribute information on the basis of operation history information and evaluation information received from the user terminal, and sequentially re-execute the selecting of the article information, the generating of the prompt sentence, and the generating of the individualized information using the updated user attribute information. This enables the server to implement an integrated computational pipeline in which natural language analysis, user modeling, prompt construction, generative processing, and personalized delivery are tightly coupled, thereby improving the technical performance of the computer system by reducing redundant data processing, dynamically adapting the amount and complexity of generated text to each user, and enhancing the efficiency and accuracy of personalized news distribution through optimized utilization of processing, memory, and network resources.

The term “article information” refers to electronic information representing one or more textual articles obtained from network resources, including at least a body of text and optionally associated metadata such as a title, a publication time, a source identifier, and a category.

The term “network resource” refers to an information source accessible via a communication network, including but not limited to web servers, feed services, and other network-accessible content distribution systems that provide article information.

The term “structured character information” refers to article information that has been converted into an organized data format, such as records, fields, or tagged segments, in which textual content and associated metadata are stored in a manner suitable for machine processing and retrieval.

The term “storage medium” refers to any non-transitory computer-readable medium capable of storing data, including semiconductor memory, magnetic storage, optical storage, and solid-state drives.

The term “natural language processing” refers to computational processing performed on human language text to analyze linguistic structure and meaning, including operations such as tokenization, sentence segmentation, part-of-speech tagging, syntactic parsing, entity recognition, keyword extraction, and related analyses.

The term “analysis information” refers to information generated by applying natural language processing to article information, the information including at least phrase information, importance information, and event information derived from the article information.

The term “phrase information” refers to units of text identified within article information, including words, multi-word expressions, or other linguistic segments that are extracted or recognized during natural language processing.

The term “importance information” refers to information indicating a relative significance or weight of phrases, sentences, or sections within article information, the significance being determined by one or more computational criteria such as frequency, contextual relevance, or statistical scoring.

The term “event information” refers to information representing one or more events described in article information, including entities, actions, temporal expressions, and relationships extracted or inferred through natural language processing.

The term “user attribute information” refers to information associated with a user that characterizes the user's preferences and capabilities, including at least interest information, knowledge level information, and reading ability information.

The term “interest information” refers to information that indicates topical preferences or favored subject areas of a user, such as domains, categories, or themes for which the user demonstrates interest.

The term “knowledge level information” refers to information representing an estimated or designated level of the user's understanding or expertise with respect to one or more topics, such as beginner, intermediate, or advanced.

The term “reading ability information” refers to information that indicates a user's preferred or suitable reading complexity, including factors such as vocabulary difficulty, sentence complexity, and acceptable text length.

The term “weighting processing” refers to a computational process in which numerical or categorical weights are assigned to article information or parts thereof based on one or more criteria, such as relevance to the user attribute information or the analysis information.

The term “ranking processing” refers to a computational process in which article information is ordered according to one or more ranking criteria, including weights, relevance scores, recency, or combinations thereof.

The term “generative information processing model” refers to a computational model that, in response to input data such as a prompt sentence, generates new text or other content, the model typically being implemented as a parameterized machine learning model such as a neural network.

The term “prompt sentence” refers to an input sequence of characters or tokens provided to a generative information processing model, the input including instructions, conditions, or contextual information that guide the generation of output content.

The term “summary information” refers to information generated by the generative information processing model that expresses the main points or essence of article information in a condensed form relative to the original article information.

The term “rewritten information” refers to information generated by the generative information processing model that represents article information with modified wording, structure, or emphasis while preserving at least a portion of the original meaning.

The term “identification information” refers to information used to uniquely or specifically identify a piece of article information or generated content, including identifiers such as record IDs, URLs, timestamps, or similar identifiers.

The term “supplementary information” refers to information associated with article information or generated content that is not part of the main text, including metadata such as a source name, category label, publication date, or link information.

The term “individualized information” refers to information that is constructed by associating summary information or rewritten information with identification information and supplementary information for specific article information in a manner tailored to a particular user based on user attribute information.

The term “user information terminal” refers to an electronic device operated by a user that is capable of communicating with the server via a communication network, including devices such as mobile terminals, tablet terminals, desktop terminals, and other client computing devices.

The term “operation history information” refers to information representing records of operations performed by a user on a user information terminal, including interactions such as selections, clicks, scrolls, openings, and other user interface actions.

The term “evaluation information” refers to information representing explicit or implicit assessments by a user regarding article information or generated content, including indications such as likes, dislikes, ratings, bookmarks, or other preference signals.

The term “server” refers to an information processing apparatus comprising at least one processor and at least one storage medium, configured to perform acquisition, analysis, generation, and distribution of information via a communication network.

In one embodiment, a server, a terminal, and a user cooperate to implement the invention. The server comprises at least one processor, a main memory, a non-transitory storage medium, and a network interface. The terminal comprises at least one processor, a display device, an input device, and a network interface. The user operates the terminal to access personalized article information generated by the server.

The server executes an operating system such as a general-purpose server operating system and executes application programs implemented, for example, in a programming language runtime environment such as a Python interpreter. The server uses one or more software libraries for network communication, text acquisition, and text analysis, including a feed parsing library, an HTML parsing library, and natural language processing libraries such as a syntactic parsing library and a tokenization library. The server also uses a generative AI model, which in one embodiment is a transformer-based neural network model deployed as an inference service accessible by the server through an application programming interface. The server stores article information, analysis information, user attribute information, and individualized information in a database system, which may be implemented using a relational database management system.

The server acquires article information from network resources by using the network interface to send requests to remote content servers over a packet-switched communication network. The server receives responses containing article data in a markup or structured data format and uses the HTML parsing library to remove markup tags, navigation elements, and non-content elements. The server converts the remaining article content into structured character information, for example, a record structure in which each record contains a textual body, a title, a publication time, a source identifier, a category identifier, and an article identifier. The server stores these records in the database in a normalized format. This structured storage allows the server to retrieve and process specific portions of the article information without repeatedly parsing the original markup, thereby reducing processing time and memory overhead.

The server performs natural language processing on the stored article information by loading a linguistic model provided by a natural language processing library such as a syntactic analysis package. The server segments each article text into tokens and sentences, assigns part-of-speech tags, and extracts phrase information, such as noun phrases and verb phrases, using a syntactic dependency tree generated by the model. The server calculates importance information for phrases and sentences by computing term frequencies, document frequencies, and statistical scores such as TF-IDF values using a numerical computation library. The server identifies event information by applying pattern-based rules and statistical entity recognition models to detect entities (for example, people, organizations, locations, and temporal expressions) and their relationships. The server stores the analysis information in the database as structured fields associated with the corresponding article record, for example as lists of keywords, entities, event descriptors, and sentence scores.

The server maintains user attribute information in one or more database tables. The server stores, for each user, an interest profile including categories or topics of interest, a knowledge level profile indicating degrees such as beginner, intermediate, or advanced for each category, and a reading ability profile indicating preferred vocabulary difficulty, text length, and sentence complexity. The server also stores operation history information and evaluation information obtained from the terminal, such as which article information the user selected, how long the user viewed the article information, and which articles the user explicitly rated as useful or not useful.

The server updates the user attribute information by applying a weighting algorithm to the operation history information and the evaluation information. In one embodiment, the server calculates, for each topic category, a relevance score that is increased when the user frequently selects or positively evaluates article information in that category and decreased when the user ignores or negatively evaluates such article information. The server stores these scores as part of the interest information. The server also adjusts the reading ability information based on observed reading behaviors, such as whether the user tends to fully read longer texts or frequently abandons long texts. By storing these computed scores and parameters in a structured form, the server can reuse them in subsequent processing cycles without recomputing them from scratch, which improves computation efficiency.

The server uses the analysis information and the user attribute information to select article information related to the user. The server computes a similarity metric between article-level feature vectors and user-level interest vectors. In one embodiment, the server constructs an article feature vector from keyword frequencies, topic indicators, and entity types derived from the analysis information. The server constructs a user feature vector from interest scores, knowledge level parameters, and reading ability parameters. The server then computes a similarity value using a vector similarity function such as cosine similarity. The server assigns a base weight to each article according to this similarity value, and further modifies the weight using recency factors derived from publication time and diversity constraints to avoid presenting near-duplicate content. The server sorts the articles according to the computed weights and selects a subset of articles for generative processing. This algorithmic selection allows the server to filter articles before they are passed to the generative AI model, thereby reducing unnecessary model invocations and improving processing throughput.

The server generates a prompt sentence for a generative AI model by combining the analysis information and the user attribute information in a structured textual form. The server fetches, from the database, key phrases, event descriptors, and summary candidate sentences for each selected article. The server also fetches user attribute information such as interest categories, knowledge level, and reading ability. The server composes a prompt sentence that explicitly encodes constraints on vocabulary level, maximum text length, and explanation style.

In one specific example, the server generates the following prompt sentence: “You are a generative AI model acting as a personal news editor. The user is interested in technology and health and has a beginner knowledge level. Rewrite the following news article in simple English, avoiding technical jargon. Use no more than 150 words. Focus on how this news affects everyday life and personal health. Important keywords and entities: [5G, wearable device, heart rate monitoring, fitness tracking]. Draft summary sentences: [‘A new wearable device uses 5G to continuously monitor heart rate.’, ‘The device aims to help users manage their daily fitness more effectively.’].”

The server passes this prompt sentence, together with the summary candidate sentences and keywords, to the generative AI model. The generative AI model, in one embodiment, is an attention-based neural network with multiple layers of self-attention blocks and feed-forward blocks, known in the art as a transformer architecture. The generative AI model represents tokens of the prompt sentence as high-dimensional embeddings and processes them through a stack of transformer layers. Each layer applies self-attention mechanisms using learned query, key, and value matrices, and then applies a position-wise feed-forward network with non-linear activation functions. The generative AI model is trained in advance on large-scale text corpora using a language modeling objective, in which the model minimizes a loss function representing prediction error for next tokens. The model's parameters, including weight matrices and bias terms, are optimized during training using gradient-based optimization, where gradients are computed by backpropagation and used to update parameters via stochastic gradient descent or a variant thereof.

The server executes an inference engine that loads the trained parameters into memory, streams the prompt sentence tokens into the model, and obtains a sequence of output tokens representing the generated summary information or rewritten information. The server constrains the generation by specifying decoding parameters such as maximum token count, temperature, and nucleus sampling threshold. By enforcing these parameters, the server ensures that the generated output respects the length constraints and style constraints encoded in the prompt sentence. The server receives the generated tokens, reconstructs them into a character string, and stores the generated summary information or rewritten information in the database along with an association to the original article identifier and the user identifier.

The server associates the generated summary information or rewritten information with identification information and supplementary information of the corresponding article information. The server constructs individualized information records that contain fields such as user identifier, article identifier, generated summary, topic labels, publication time, and source identifier. The server bundles multiple individualized information records into a personalized feed data structure and transmits this structure to the terminal through the network interface using a communication protocol such as HTTP over a secure connection. By transmitting only the individualized information, which is shorter and more focused than the raw article information, the server reduces communication load between the server and the terminal, thereby improving network efficiency.

The terminal receives the personalized feed data from the server and stores it temporarily in terminal memory. The terminal parses the individualized information and renders the generated summary information or rewritten information on the display device using graphical user interface components. The terminal arranges titles, summaries, and metadata in a list or grid layout and allows the user to select items for detailed viewing. When the user selects a particular item, the terminal displays the corresponding generated summary or rewritten article, and may optionally provide a link to the full original article stored on a remote content server.

The user interacts with the terminal by performing operations such as selecting articles, scrolling through lists, marking items as preferred, or dismissing items. The terminal records these operations as operation history information, and records explicit evaluations such as “like,” “dislike,” or “save for later” as evaluation information. The terminal transmits this information back to the server. The server processes this information to update the user attribute information. In one embodiment, the server maintains a per-category score vector and updates each component by applying a weighted moving average of recent interactions. This feedback loop causes user attribute information to reflect recent user behavior, improving the accuracy of article selection and prompt construction.

The server, by integrating natural language processing, user modeling, prompt generation, and generative model inference into a single computational pipeline, improves computer technology in several ways. The server reduces redundant processing by storing intermediate analysis information and user attribute information in structured form, thereby avoiding repeated full-text analysis for each personalization request. The server reduces the number of generative model invocations and the length of model outputs by pre-selecting relevant article information and constraining generation via prompt sentences and decoding parameters, leading to lower computation time and reduced use of hardware resources such as central processing units and graphics processing units. The server improves the precision of personalized content by encoding user profiles directly into prompt sentences, which affects token-level generation behavior inside the transformer model and yields outputs that better match the desired vocabulary level and content focus. The server improves data management by using normalized database schemas and feature vectors that allow efficient indexing and retrieval of article information and user profiles.

The server also implements non-conventional processing that is not a mere automation of human editorial work. A human editor cannot directly adjust neural network weights, compute high-dimensional similarity metrics, or manage large-scale article-feature vectors and user-feature vectors in real time. The server uses specific computational rules, such as vector similarity calculations, ranking algorithms, and parameterized decoding strategies, to control the behavior of the generative AI model in a way that reduces error rates in content relevance and reading-level matching. For example, by restricting generation length at the decoding stage and choosing tokens according to probability distributions conditioned on the user attribute information encoded in the prompt sentence, the server avoids generation of unnecessarily verbose or overly technical content. This controlled generation process leads to lower latency and better alignment with user preferences compared to systems that use static templates or unconstrained generation.

In another embodiment, the server uses a generative AI model that is fine-tuned on a domain-specific corpus of summarized news articles. The server trains the model by presenting pairs of original article segments and target summaries, and by minimizing a loss function such as cross-entropy between predicted tokens and reference tokens. The server adjusts learning rates, batch sizes, and regularization parameters to optimize generalization and prevent overfitting. During training, the server may use data augmentation techniques such as shuffling sentence orders within constraints or injecting paraphrasing variants to increase robustness. This fine-tuned model, when used for inference in the described pipeline, produces summaries that exhibit higher factual consistency and better adherence to length and style constraints, reducing the need for post-processing and manual correction.

In yet another embodiment, the server uses a different data structure for article information and analysis information, such as a graph structure in which nodes represent entities, events, and topics, and edges represent relationships between these nodes. The server then computes centrality measures or path-based relevance scores to select article information related to the user. This graph-based approach further refines the selection of content for prompt generation and can reduce the number of irrelevant or redundant items presented to the user, thereby improving the perceived quality and efficiency of the system.

In still another embodiment, the terminal implements local caching and prefetching functions. The terminal stores recently received individualized information in a local database and, based on predictions about the user's reading patterns, requests additional individualized information from the server in advance. This reduces perceived latency for the user and spreads network usage over time, which can reduce peak communication load. The server can adapt the size and frequency of such prefetching based on network conditions and user attribute information, thereby optimizing network resource utilization at a system level.

Through these embodiments, the server, the terminal, and the user interact in a way that reconfigures the operation of computing hardware and software components to achieve technical effects such as faster personalized content delivery, improved relevance and readability of generated content, reduced network transmission volume, and more efficient utilization of processing resources. The described architecture, data structures, and algorithms provide concrete technical means for implementing the claimed system and enable a person skilled in the art to realize and modify the invention in various forms while maintaining the core inventive concept of prompt-based, user-attribute-driven generation of individualized article information using a generative AI model.

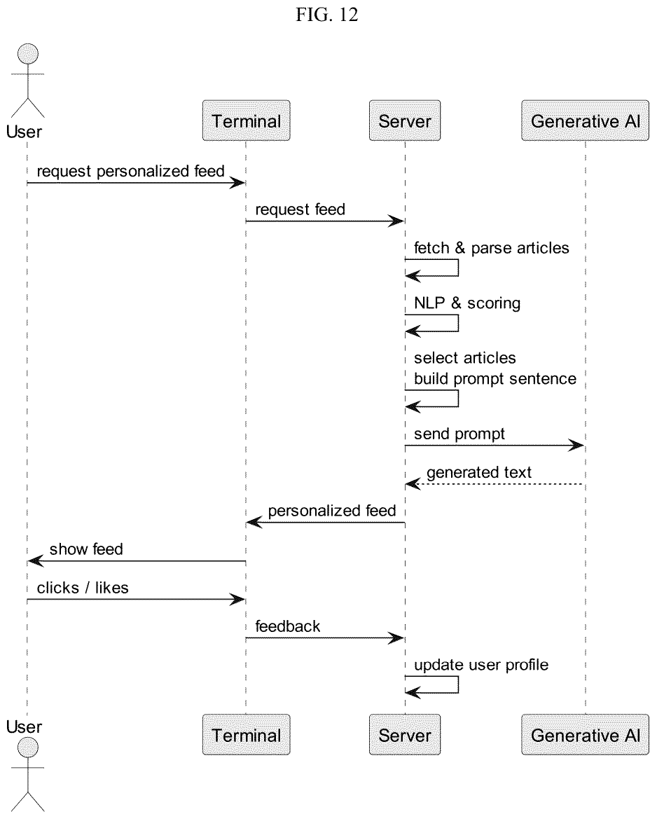

The following describes the processing flow using FIG. 12.

### Step 1

The server retrieves article information from network resources.

The server uses the network interface to send request messages to one or more content servers on the network, based on a stored list of resource addresses. The input of this step is a set of resource addresses (for example, feed URLs and webpage URLs) stored in a configuration database or file. The server receives response messages that contain article data in markup or structured formats. The server uses an HTML parsing function to remove markup tags, navigation elements, and advertisements from the responses, and converts the remaining text into structured records. The output of this step is a collection of article records, each containing at least a title field, a body text field, a publication time field, a source identifier field, and an article identifier field, which the server stores in a storage medium.

### Step 2

The server performs natural language processing on the stored article information.

The server reads unprocessed article records from the database; these records constitute the input of this step. The server loads a natural language processing model and applies tokenization, sentence segmentation, and part-of-speech tagging to each article body text. The server then extracts phrase information such as noun phrases and verb phrases by analyzing syntactic dependencies, and computes importance scores for tokens and sentences using statistical measures such as term frequency and inverse document frequency. The server detects event information by identifying named entities and their relationships, using pattern-based rules and learned entity recognition parameters. The server writes the resulting analysis information back to the database as additional fields associated with each article record. The output of this step is a set of enriched article records that now include phrase information, importance information, and event information.

### Step 3

The server maintains and updates user attribute information.

The server receives operation history information and evaluation information from the terminal as the input of this step. The operation history information includes records of article selections, viewing durations, and navigation actions, and the evaluation information includes explicit user responses such as likes or dislikes. The server aggregates these inputs per user and per topic category. The server then applies a weighting algorithm that updates interest scores, knowledge level estimates, and reading ability parameters based on the aggregated statistics. For example, the server increases a category interest score when the user frequently selects and positively evaluates articles in that category, and decreases the score when the user ignores or negatively evaluates such articles. The server stores the updated user attribute information in dedicated user profile tables. The output of this step is a set of user attribute records that reflect current interest information, knowledge level information, and reading ability information for each user.

### Step 4

The server selects article information relevant to a user.

The input of this step is the enriched article records generated in Step 2 and the updated user attribute information generated in Step 3. The server constructs, for each article, a feature vector from the analysis information, including weighted keyword counts, topic indicators, and entity-type encodings. The server constructs, for each user, a profile vector from interest scores, knowledge level parameters, and reading ability parameters. The server computes similarity metrics between article feature vectors and the user profile vector using a vector similarity function. The server then applies weighting processing in which the similarity metrics are combined with recency factors derived from article publication times and diversity penalties that reduce weights of highly similar articles. The server orders the articles by the resulting weights and selects a subset of articles with the highest weights. The output of this step is a list of selected article identifiers and their associated analysis information for the target user.

### Step 5

The server generates a prompt sentence for a generative AI model.

The input of this step is the analysis information and metadata for the selected articles from Step 4 and the user attribute information from Step 3. The server retrieves, for each selected article, key phrases, event descriptions, and summary candidate sentences stored in the enriched article records. The server also retrieves the user's interest categories, knowledge level, and reading ability constraints such as preferred maximum text length and vocabulary difficulty. The server assembles these elements into a structured natural language instruction, which constitutes the prompt sentence. During this assembly, the server inserts explicit statements that describe the user's interests, the required length limit, and the desired explanation style into the text of the prompt. The output of this step is one or more prompt sentences, each associated with an article identifier and a user identifier, which the server prepares for submission to the generative AI model.

### Step 6

The server invokes the generative AI model and generates summary information or rewritten information.

The input of this step is the prompt sentence or sentences produced in Step 5. The server sends the prompt sentences to the generative AI model using an application programming interface, specifying decoding parameters such as maximum output length and randomness controls. The generative AI model processes the prompt sentence by converting characters or tokens into numerical embeddings, applying multiple layers of self-attention and feed-forward transformations according to its trained parameters, and producing a sequence of output tokens. The server receives the output tokens, reconstructs them into human-readable text, and designates this text as summary information or rewritten information for the corresponding article. The output of this step is a set of generated texts, each linked to the respective article identifier and user identifier.

### Step 7

The server generates individualized information and prepares a personalized feed.

The input of this step is the generated summary information or rewritten information from Step 6, together with the original article identification information and supplementary information such as publication time and source. The server creates individualized information records by combining these data elements into structured objects that contain user identifiers, article identifiers, generated text fields, and metadata fields. The server aggregates multiple individualized information records into a personalized feed data structure for the user. The server formats this structure into a transmission format such as a structured text representation and attaches address information of the terminal. The output of this step is a personalized feed package ready for transmission to the terminal.

### Step 8

The server transmits the personalized feed, and the terminal receives it.

The input of this step on the server side is the personalized feed package produced in Step 7, and the input on the terminal side is a request message triggered by the user or an internal schedule. The server uses the network interface to send the personalized feed package over the communication network to the terminal. The terminal receives the incoming data via its network interface and stores the data in terminal memory. The terminal parses the structured text into internal data objects, extracting individualized information records for each article. The output on the server side is a completed transmission of the personalized feed, and the output on the terminal side is a set of parsed individualized information objects stored locally.

### Step 9

The terminal displays the individualized information to the user.

The input of this step is the set of individualized information objects generated in Step 8. The terminal uses its processor to generate display layouts that include article titles, generated summaries or rewrites, and supplementary information such as source names and publication times. The terminal maps text content to visual components such as list items or cards, and draws these components on the display device. When the user selects a particular item on the display, the terminal loads the corresponding generated text and renders it in a detailed view. The output of this step is a visual presentation of the personalized feed on the display, enabling the user to read and scroll through the content.

### Step 10

The user interacts with the displayed individualized information.

The input of this step is the visual presentation of the individualized information on the terminal display. The user performs operations such as tapping on items, scrolling, marking items as preferred or not preferred, and closing or ignoring items. These physical operations are converted by the terminal into digital events. The terminal records the sequence of events, including article identifiers, timestamps, and event types such as “open,” “like,” or “dismiss.” The output of this step is a log of operation history information and evaluation information stored temporarily on the terminal.

### Step 11

The terminal transmits feedback, and the server updates user attribute information.

The input of this step on the terminal side is the log of operation history information and evaluation information created in Step 10. The terminal bundles these log entries into a feedback message and transmits the message to the server using the network interface. The server receives the feedback message and parses the enclosed log entries. The server aggregates the logs with existing user attribute information and recalculates interest scores, knowledge level estimates, and reading ability parameters based on predefined rules or statistical models. The server updates the corresponding user records in the database. The output of this step on the server side is a refreshed set of user attribute information that will be used as input in subsequent executions of Steps 4 through 7, thereby closing the feedback loop for continuous personalization.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that provide news or other textual information to end users typically perform fixed-format summarization or filtering using static rules or simple machine learning models. Such systems are limited in several technical respects. First, the systems generally do not dynamically generate machine-consumable instructions for advanced language models; instead, they apply uniform processing pipelines to all users, which leads to inefficient use of computational resources and network bandwidth because excessive or irrelevant information must be transmitted and rendered at the terminal side. Second, content adaptation to user attributes, such as domain expertise or preferred detail level, is often implemented as post-processing on the terminal or through multiple, separately maintained content versions, which increases memory usage, processing overhead, and system complexity. Third, existing systems typically lack a mechanism for programmatically and iteratively modifying instructions to a generative AI model in response to user feedback, information type, or inferred emotional state, resulting in repeated end-to-end processing and redundant model calls, thereby degrading latency and throughput in distributed computing environments.

Further, when a generative AI model is used merely as a black-box summarizer, the server has limited control over the internal processing steps, and cannot efficiently separate an extraction phase from a reconstruction phase. As a result, it is difficult to optimize network traffic between server and model, to cache intermediate results for reuse, or to tune the style and tone of the output for different user sessions without reprocessing the original content. Additionally, lack of structured prompt management on the server side makes it challenging to guarantee consistent quality of generated outputs across heterogeneous user devices and varying network conditions.

Accordingly, there is a need for a technical mechanism implemented at the server side that (i) programmatically constructs and manages prompt sentences for a generative AI model, (ii) separates content extraction and reconstruction into distinct, controllable stages, (iii) adapts both stages to user attribute information and emotional state, and (iv) supports iterative refinement based on user requests. Such a mechanism should improve the efficiency, responsiveness, and scalability of a computer-based information delivery system, while reducing redundant computation and network usage and increasing controllability of the generative AI model behavior at runtime.

The specific processing by the specific processing unit 290 of the data processing device 12 in Example 2 is realized by the following means.

The present invention provides a server comprising a processor configured to receive information as input, to acquire the information according to an acquisition source of the information and generate text data in a form from which main content can be extracted, to generate a first prompt sentence that instructs a generative AI model to analyze the text data and extract important content based on attribute information of a user, to transmit the first prompt sentence and the text data to the generative AI model and obtain extraction result data from the generative AI model, to generate a second prompt sentence that instructs the generative AI model to reconstruct the extraction result data into an expression form adapted to the user based on the extraction result data and the attribute information of the user, to transmit the second prompt sentence and the extraction result data to the generative AI model and obtain reconstructed information data corresponding to the attribute information of the user from the generative AI model, to generate the reconstructed information data as output data and transmit the output data to an external apparatus, and optionally to acquire state information relating to an emotional state of the user and modify at least one prompt sentence provided to the generative AI model based on the state information so as to change a tone of the reconstructed information data, and to sequentially change at least one prompt sentence provided to the generative AI model according to a type of the information, the attribute information of the user, and an additional request from the user and re-instruct the generative AI model so as to perform at least one of detailing, summarizing, and changing an expression format of the reconstructed information data. This enables the server to control, at a technical level, a multi-stage interaction with the generative AI model through dynamically constructed prompt sentences, to separate extraction processing from reconstruction processing, to reuse intermediate extraction results, to adapt the style and tone of generated information to user attributes and emotional state, and to iteratively refine outputs based on user feedback, thereby improving computational efficiency, reducing network load, and enhancing responsiveness and scalability of the overall computer-implemented information delivery system.

The term “processor” refers to a hardware or virtual computation unit, such as a central processing unit, a graphics processing unit, or a combination of such units, that executes machine-readable instructions to perform data processing operations.

The term “information” refers to digital data including at least text data, metadata, or identifiers such as uniform resource locators, which is received by the system as a target for analysis and reconstruction.

The term “acquisition source” refers to a technical origin of the information, including at least a remote server accessible via a communication network, a local storage device, or an input interface of a terminal.

The term “text data” refers to character-based data obtained by converting information from its acquisition source into a normalized textual form suitable for analysis by a language processing model.

The term “main content” refers to a subset of the text data that is determined to be semantically important or relevant according to predetermined criteria such as topical relevance, user attributes, or task-specific instructions.

The term “user” refers to an entity, such as a human operator or another system, that receives reconstructed information data from the system and for which attribute information and emotional state information may be maintained.

The term “attribute information of a user” refers to digital data indicating at least one characteristic of the user, such as domain expertise, knowledge level, preferred detail level, preferred output format, or target audience category.

The term “generative AI model” refers to a parameterized machine learning model configured to generate text data in response to input text and instructions, including models based on neural network architectures such as transformer architectures.

The term “prompt sentence” refers to machine-readable instruction text that specifies to the generative AI model how to process input text data, including at least a task description, constraints, target style, or target audience.

The term “first prompt sentence” refers to a prompt sentence that instructs the generative AI model to analyze the text data and extract important content based on the attribute information of the user.

The term “extraction result data” refers to text data generated by the generative AI model in response to the first prompt sentence, the text data representing content extracted or summarized from the original text data.

The term “second prompt sentence” refers to a prompt sentence that instructs the generative AI model to reconstruct the extraction result data into an expression form adapted to the user based on the attribute information of the user.

The term “reconstructed information data” refers to text data generated by the generative AI model in response to the second prompt sentence, the text data being organized, worded, or formatted in a style tailored to the attribute information of the user.

The term “expression form” refers to a style or structure of text, including at least a choice of vocabulary, level of technicality, degree of detail, layout such as bullet points or paragraphs, and narrative tone.

The term “output data” refers to data including at least the reconstructed information data and optionally associated metadata, which is generated by the processor for delivery to an external apparatus.

The term “external apparatus” refers to a device or system external to the server, including at least a user terminal, a client application, or another server, that receives the output data via a communication interface.

The term “state information” refers to data representing an inferred or explicitly provided emotional state of the user, such as calm, anxious, curious, or frustrated, derived from user inputs, behavioral signals, or external sensors.

The term “emotional state” refers to an affective condition of the user, represented in the system as one or more categories or parameters used to adjust the tone or style of the reconstructed information data.

The term “tone” refers to an overall affective style of the reconstructed information data, including aspects such as politeness, formality, encouragement, urgency, or reassurance, which can be modified based on the emotional state of the user.

The term “information type” refers to a classification of the information, including at least categories such as news, technical documentation, medical content, educational material, or entertainment content, used to determine prompt construction.

The term “additional request from the user” refers to an instruction or feedback provided by the user after receiving an output, such as a request for more detail, less detail, a simpler explanation, or a different format.

The term “detailing” refers to an operation in which the generative AI model expands the reconstructed information data by adding explanations, examples, or technical specifics to increase the level of detail.

The term “summarizing” refers to an operation in which the generative AI model reduces the reconstructed information data by omitting less important content and condensing key points.

The term “expression format” refers to a structural format of the reconstructed information data, including at least bullet lists, numbered lists, paragraph-style text, sectioned text with headings, or question-and-answer formats.

The term “sequentially change” refers to a process in which at least one prompt sentence is modified over time across multiple interactions with the generative AI model, based on newly available information type, updated user attribute information, or additional user requests.

In one embodiment, a server implements the claimed system as a network-connected computing apparatus comprising at least one central processing unit (CPU), at least one graphics processing unit (GPU) or other accelerator, a main memory, a non-volatile storage device, and a network interface. The server executes an operating system such as a general-purpose server operating system and one or more application programs that implement the functions described in the claims. The server communicates with at least one terminal via a wired or wireless network, for example using standard Internet protocols.

The server stores a generative AI model as a parameterized neural network in the storage device and loads the model into the main memory for inference. In one example, the generative AI model implements a transformer-based architecture with multiple self-attention layers, feed-forward layers, and embedding layers. The server stores model parameters such as weight matrices, bias vectors, and layer-normalization parameters, and uses them to compute token embeddings, attention scores, and output token probabilities. The server may implement the model locally using a machine learning framework or may access the model via an external inference service through an application programming interface.

The server maintains one or more data structures in memory and storage to support the processing flow. For example, the server maintains a user profile table that stores attribute information of each user, such as domain expertise level, preferred language complexity, preferred output format, and historical interaction patterns. The server maintains an information log that stores identifiers of input information, acquisition sources (for example, resource locators, file identifiers, or content identifiers), and normalized text data obtained from those sources. The server also maintains a prompt management structure that stores templates for prompt sentences, with slots for inserting variable values such as user attributes, information type, and control parameters.

The server uses specific software components to implement data acquisition and preprocessing. For example, the server runs a web application framework to receive requests from the terminal, and uses an HTTP client library to retrieve web content when the input information is provided as a network resource identifier. The server uses an HTML parsing library to strip markup tags and extract the main textual content from a web page. The server normalizes the textual content by converting character encodings, removing unwanted markup, and segmenting the text into paragraphs or sentences. The normalized text is stored as text data in an internal format.

The server uses attribute information of the user to control the behavior of the generative AI model at a technical level. The server maps attribute values, such as “expert-level medical professional” or “general reader,” to parameter sets that specify a desired level of detail, vocabulary complexity, and structural format. The server then uses these parameter sets to select or construct a first prompt sentence and a second prompt sentence. The server represents each prompt sentence as a sequence of tokens that are concatenated with the tokenized text data or extraction result data before being passed to the generative AI model.

The server constructs the first prompt sentence so that the generative AI model is instructed to perform an extraction operation rather than a monolithic end-to-end summarization. For example, when the user is a medical professional, the server may construct a first prompt sentence such as:

“You are an expert medical assistant. From the following text, extract only the information related to heart disease treatments, clinical trials, patient outcomes, and key medical findings. Present the extracted information as structured bullet points, grouped by treatment type.”

When the user is a general reader, the server may construct a first prompt sentence such as:

“You are a helpful news assistant. From the following text, extract the most important points that a general reader should know about health and lifestyle. Avoid technical terminology where possible and identify at most five key points.”

The server appends the first prompt sentence and the normalized text data to form an input sequence for the generative AI model. Internally, the server converts the characters of the prompt sentence and text data to token identifiers using a tokenizer associated with the generative AI model. The server then arranges the token identifiers in a specific sequence that begins with system-level instructions, continues with the first prompt sentence, and then contains the text data. The server passes this sequence to the generative AI model along with control parameters such as maximum output length, sampling temperature, and decoding strategy.

The server executes the generative AI model on the GPU or other accelerator, which performs matrix multiplications and attention computations over the token sequence. The model computes attention weights that relate tokens in the prompt sentence to tokens in the text data, thereby conditioning the extraction operation on the user-specific instructions. The server obtains extraction result data as a sequence of output tokens from the model. The server converts the output tokens to characters to obtain natural-language extraction result data. The server stores the extraction result data in an intermediate data structure associated with the original information identifier and the user identifier.

The server constructs the second prompt sentence using both the extraction result data and the attribute information of the user. For example, when the user is a cardiologist, the server may construct a second prompt sentence such as:

“You are writing for a cardiologist. Using the extracted information below, create a detailed technical summary. Include clinical trial design, patient population, endpoints, statistical significance when available, and potential clinical implications. Do not oversimplify and retain medical terminology.”

When the user is a general news reader, the server may construct a second prompt sentence such as:

“You are writing for a general news reader. Using the extracted information below, explain the key points in clear, simple language. Avoid jargon, use short sentences, and give one everyday example to illustrate the main idea.”

The server concatenates the second prompt sentence with the extraction result data to form a second input sequence for the generative AI model. Similar to the first input sequence, the server tokenizes the second prompt sentence and the extraction result data, and feeds the resulting token sequence into the model with appropriate control parameters. The generative AI model then computes a reconstructed information data sequence that is more heavily influenced by the user-specific instructions in the second prompt sentence. The server obtains the reconstructed information data as decoded text and stores it as output data.

The server optionally acquires state information related to an emotional state of the user. The server may infer the emotional state from interaction patterns, such as rapid repeated requests, negative feedback inputs, or explicit user selections in a user interface on the terminal. The server maps the emotional state to a tone profile, such as “reassuring,” “concise and neutral,” or “encouraging.” The server then modifies at least one of the prompt sentences by inserting language that controls tone, for example:

“Adopt a calm and reassuring tone, emphasizing safety and clear guidance.”

or

“Use concise and neutral language, avoiding emotional expressions.”

By embedding tone instructions directly into the prompt sentences, the server causes the generative AI model to generate text with a tunable affective style that corresponds to the emotional state.

The terminal operates as a client device that communicates with the server and presents reconstructed information data to the user. The terminal may be a general-purpose computing device such as a smartphone, tablet, or personal computer. The terminal runs a client application or a web browser that displays a user interface for entering input information, selecting user attributes, and reviewing reconstructed outputs. The terminal sends user inputs to the server via the network and receives output data from the server. The terminal may also collect optional feedback signals, such as user ratings, follow-up questions, or mode switches, and forward them to the server. The terminal may not perform complex language processing; instead, it relies on the server-side processing to reduce computational load and to standardize processing quality across devices.

The user interacts with the terminal to provide information and control preferences. The user may input a web page address, paste a block of text, or select a stored document as input information. The user may also set or adjust attribute information, such as selecting “medical professional,” “general reader,” or “student,” and may specify desired output characteristics such as “detailed explanation” or “short summary.” After receiving reconstructed information data from the server, the user may issue additional requests, such as “make this shorter,” “add more technical detail,” or “explain this for a teenager.” The server treats these additional requests as triggers to construct new prompt sentences that reference the previously generated reconstructed information data, thereby achieving iterative refinement without reprocessing the original text.

The server implements a non-traditional processing sequence that separates extraction and reconstruction into distinct stages, and that manages prompt sentences as structured, machine-controlled objects. In contrast to systems that simply send raw text to a generative AI model with a generic instruction, the server explicitly generates and modifies prompt sentences in response to user attributes, information type, and emotional state. The server uses internal rules or learned mappings to decide which prompt template to select, how to fill variable slots in the template, and how to adjust control parameters for the generative AI model. This design leads to improved computational efficiency, because extraction result data can be cached and reused for multiple different reconstructions. For example, once extraction result data has been generated for a particular article, the server can produce both a technical reconstruction and a layperson reconstruction without repeating the extraction computation. This reduces the number of full-text model inferences, lowering GPU utilization and improving overall throughput.

The server improves data management by storing intermediate extraction result data in association with metadata such as information type and user segment. The server can quickly retrieve and recombine extraction result data for different reconstruction tasks, which reduces duplicate storage of full original content and allows fine-grained versioning of outputs. By limiting subsequent reconstructions to shorter extraction result data, the server reduces the token length of model inputs in later stages, which lowers inference time and memory consumption.

The server improves communication efficiency by transmitting only reconstructed information data or compact extraction result data to the terminal, rather than transmitting the entire original text. In scenarios where the original content is large, the server's separation of extraction and reconstruction reduces network bandwidth usage between server and terminal. Additionally, when the generative AI model is hosted on a separate inference server, the server can choose to cache extraction result data and only transmit such intermediate summaries to the inference server for reconstruction. This reduces data transfer volume between computational nodes and shortens response time.

The server implements a specific neural network training and inference configuration to support the described behavior. During training, the generative AI model is trained on corpora that include pairs of prompt sentences and desired outputs. The training process uses an objective function such as cross-entropy loss between predicted tokens and target tokens.

The server or a training system updates model parameters by backpropagation, adjusting weight matrices according to gradients derived from the loss. In some embodiments, the server performs fine-tuning using domain-specific datasets that contain instructions for extraction and reconstruction tasks, such as “extract clinical findings” or “rewrite for a general audience.” This fine-tuning causes internal representations of the generative AI model to be more sensitive to prompt-level distinctions between extraction and reconstruction instructions.

The server further applies specific prompt engineering rules that are not equivalent to simple human editing. For example, the server may automatically compute a complexity score for the original text by analyzing sentence length, technical term frequency, and domain-specific vocabulary. The server then adjusts the first and second prompt sentences by adding constraints such as “explain any terms longer than a certain character length” or “limit each bullet point to a specific number of words.” These constraints are generated algorithmically based on measurable properties of the text and user attributes, rather than by a human author. This non-conventional step ensures that the generative AI model is guided by machine-derived rules, producing outputs that improve readability and consistency in a manner that is difficult to achieve manually.

In additional embodiments, the server uses different variants of the generative AI model for the extraction and reconstruction stages. For example, the server may use a model variant optimized for long-context processing for extraction, and a smaller model variant optimized for stylistic rewriting for reconstruction. The server selects the model variant based on information type and length, thereby reducing resource consumption. The server also adjusts decoding strategies such as beam search width, top-k sampling, or nucleus sampling according to the desired output variability. For example, the server may use a more deterministic decoding method for professional summaries and a more diverse sampling method for general audience explanations.

The server can be deployed in different configurations. In one configuration, the server hosts both the application logic and the generative AI model on the same physical hardware, which reduces latency by avoiding cross-machine network communication. In another configuration, the server acts as an intermediary between the terminal and a remote inference service that hosts the generative AI model. In this case, the server still performs prompt generation, attribute-based control, caching of extraction result data, and management of user profiles, while delegating neural network computation to the remote service. In yet another configuration, the server can be distributed across multiple nodes, each handling specific functions such as data acquisition, prompt management, model inference, and output delivery.

By structuring processing around explicit first and second prompt sentences, and by controlling model behavior through machine-generated instructions, the server improves the functioning of the computer system itself. The separation of extraction and reconstruction reduces overall computation, intermediate storage size, and data transfer volume, thereby improving processing speed and responsiveness. The attribute-based and emotion-based control of prompt sentences increases accuracy and relevance of generated outputs, which reduces the need for re-queries and redundant computations. The ability to reuse extraction result data for multiple reconstructions provides a technical mechanism for caching and reusing intermediate model outputs, which is distinct from simply caching final results.

In summary, the server, terminal, and user cooperate to implement the claimed system. The server performs structured acquisition and normalization of information, maintains user attribute and emotional state information, generates and iteratively refines prompt sentences in a machine-controlled manner, and manages a generative AI model that is technically configured for staged extraction and reconstruction. The terminal provides a user interface and communication conduit without requiring heavy local processing, and the user provides preferences and feedback that are transformed by the server into quantitative control parameters and structured instructions. This combined configuration achieves technical effects in terms of improved computational efficiency, reduced communication load, enhanced scalability, and higher-quality adaptive text generation, going beyond mere automation of human summarization or editing.

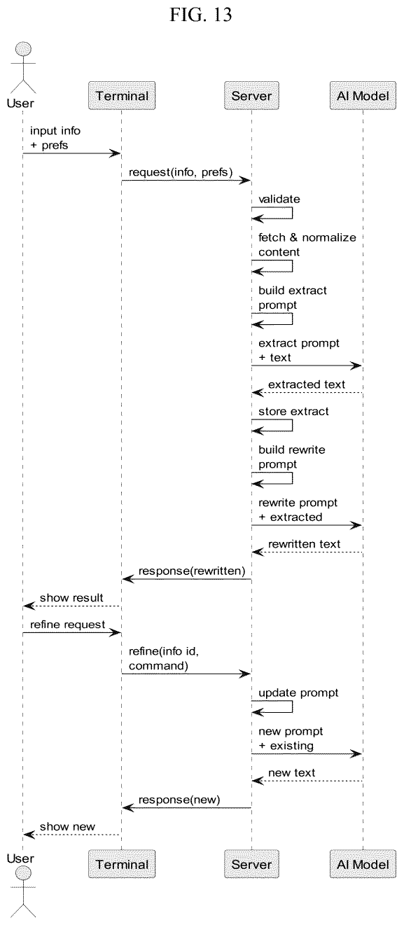

The following describes the processing flow using FIG. 13.

### Step 1

User operates the terminal to provide input information and user attributes.

User enters or selects an information source (for example, a URL or text) and optionally selects or confirms attribute information such as “medical professional” or “general reader” on the terminal interface. The input of this step is user actions (typing, clicking, selecting options), and the output is structured input data on the terminal, such as a URL string, raw text, and attribute selections stored in UI variables.

### Step 2

Terminal sends structured input data to the server.

Terminal takes the URL, text, and attribute selections from the UI variables as input and serializes them into a request message, for example, a JSON payload. Terminal then transmits this request to the server over a network connection using a communication protocol. The input of this step is the structured input data in the client application, and the output is a network request containing that data, addressed to a server endpoint.

### Step 3

Server receives and validates the request.

Server accepts the network request from the terminal as input and parses the request header and body. Server validates fields such as presence of an information source, syntactic correctness of the URL, and validity of user attribute values. Server may discard malformed requests or return an error message, and may log errors for monitoring. The input of this step is the raw network request, and the output is a validated request object in server memory that contains a normalized representation of the information source and user attributes.

### Step 4

Server acquires raw information content from the acquisition source.

Server examines the validated request object as input to determine whether the acquisition source is a URL, a direct text block, or another resource identifier. When the input is a URL, server issues an outbound network request to the content server and receives HTML or other markup as response. When the input is text, server directly uses the text from the request. Server extracts payload data from the content server response, such as the HTML body. The input of this step is the acquisition source identifier from the validated request, and the output is raw content data (for example, full HTML content or a raw text string) stored temporarily in server memory.

### Step 5

Server normalizes raw content into text data.

Server takes the raw content data as input and applies preprocessing operations. When the raw content is HTML, server uses an HTML parser to remove tags, scripts, and navigation elements and to isolate the main article body. Server then performs normalization, such as decoding character encodings, removing extra whitespace, splitting the content into paragraphs or sentences, and optionally filtering out duplicated or irrelevant sections. Server writes the normalized text into a text data structure. The input of this step is unstructured raw content, and the output is normalized text data suitable for tokenization and further analysis.

### Step 6

Server retrieves and refines user attribute information.

Server takes the user identifier or attribute values from the validated request as input and queries a user profile store or internal configuration to obtain additional attribute information, such as preferred detail level, preferred output format, and domain expertise. Server then merges request-level attributes with stored attributes, resolving conflicts according to predefined rules (for example, giving priority to explicit user selections over defaults). The input of this step is basic attribute information and user profile data, and the output is a consolidated attribute information structure that will condition subsequent processing.

### Step 7

Server classifies the information type.

Server uses the normalized text data and optionally metadata (such as URL domain or tags) as input and runs a classification routine to identify the information type, for example, “medical news,” “technical report,” or “general news.” Server may use keyword detection, a shallow classifier, or a lightweight model to determine the category. The classification algorithm computes feature values (such as term frequencies and domain-specific word occurrences) and maps them to a type label. The input of this step is the normalized text and metadata, and the output is an information type label stored with the text data.

### Step 8

Server selects a prompt template for extraction.

Server uses the consolidated attribute information and the information type label as input to a template selection module. Server consults a template registry, which maps combinations of user attributes and information types to predefined prompt templates for extraction. Server selects a base extraction template, such as one optimized for medical professionals or one optimized for general readers. The input of this step is the attribute information and information type label, and the output is a selected extraction prompt template that contains placeholders for variable parts.

### Step 9

Server instantiates the first prompt sentence for extraction.

Server takes the selected extraction prompt template and the attribute information as input and fills placeholders with specific instructions, such as target domain, detail level, and output structure. For example, when the user is a medical professional, server inserts phrases like “clinical trials” and “statistical significance” into the template. Server concatenates the resulting first prompt sentence with the normalized text data. The input of this step is the prompt template and configuration values derived from attributes, and the output is a concrete first prompt sentence and a combined prompt-plus-text input string.

### Step 10

Server tokenizes prompt and text for the generative AI model.

Server takes the first prompt sentence and the normalized text data as input and applies a tokenizer specific to the generative AI model. Server converts characters and words into token identifiers, applies any required special tokens to mark boundaries (such as beginning-of-sequence or separator tokens), and constructs a token sequence in the order expected by the model. The input of this step is the textual prompt and article text, and the output is a numerical token sequence that encodes the full extraction instruction and content.

### Step 11

Server performs extraction inference with the generative AI model.

Server supplies the token sequence and decoding parameters as input to the generative AI model, which executes on a GPU or other accelerator. The model performs numerical operations such as matrix multiplications, attention weight calculations, and non-linear transformations at each layer. At each generation step, the model computes probability distributions over possible next tokens conditioned on the existing token context, and server selects the most appropriate next token using a decoding strategy. The input of this step is the tokenized prompt and text plus model parameters, and the output is a token sequence representing extraction result data.

### Step 12

Server decodes extraction result tokens into text.

Server takes the extraction result token sequence as input and applies the tokenizer's decoding function to translate token identifiers back into characters and words. Server removes any special tokens and post-processes the text (for example, normalizing whitespace and correcting simple formatting). The input of this step is the numerical token sequence from the model output, and the output is extraction result data as natural-language text stored as an intermediate representation associated with the request.

### Step 13

Server stores and indexes extraction result data.

Server uses the extraction result text, along with the original information identifier and user identifier, as input to a storage module. Server writes an entry to an intermediate results store with fields such as information ID, user ID, information type, timestamp, and extraction result text. Server may also compute a hash or index to permit fast retrieval for future reconstructions. The input of this step is the extraction result data and metadata, and the output is a persistent or cached record enabling reuse of the extraction result without recomputing it.

### Step 14

Server selects a prompt template for reconstruction.

Server takes the consolidated attribute information, the information type, and optionally emotional state information as input and queries a reconstruction prompt template registry. Server selects a template that aligns with the target audience and tone, for example, “expert technical summary” or “simple news explanation.” The input of this step is attribute information, information type, and emotional state (if available), and the output is a reconstruction prompt template specifying style, tone, and structural requirements.

### Step 15

Server instantiates the second prompt sentence for reconstruction.

Server uses the selected reconstruction template, the attribute information, and any emotional tone parameters as input and fills template placeholders to construct a second prompt sentence. Server may add instructions like “use a calm and reassuring tone” or “avoid jargon and use short sentences.” Server then combines this second prompt sentence with the extraction result text. The input of this step is the reconstruction template and configuration variables, and the output is a concrete second prompt sentence plus a combined prompt-plus-extraction string ready for tokenization.

### Step 16

Server tokenizes reconstruction prompt and extraction result data.

Server takes the second prompt sentence and the extraction result text as input and again applies the generative AI model's tokenizer. Server generates token identifiers, appends appropriate special tokens, and forms an ordered token sequence that presents the reconstruction instructions followed by the extracted content. The input of this step is textual prompt and extraction result, and the output is a token sequence representing the reconstruction task.

### Step 17

Server performs reconstruction inference with the generative AI model.

Server feeds the reconstruction token sequence and associated decoding parameters into the generative AI model as input. The model processes the tokens through its layers, computing attention over both instruction tokens and extraction result tokens, and generates new output tokens that reflect stylistic and structural constraints encoded in the second prompt sentence. The input of this step is the reconstruction token sequence and model state, and the output is a token sequence representing reconstructed information data tailored to the user.

### Step 18

Server decodes reconstructed information tokens into text.

Server takes the reconstructed token sequence as input and decodes it into text using the tokenizer's inverse mapping. Server post-processes the text, for example, enforcing paragraph breaks, ensuring list bullet formatting, and removing unwanted artifacts. The input of this step is the sequence of generated tokens, and the output is reconstructed information data in human-readable form that reflects user attributes and desired tone.

### Step 19

Server packages reconstructed information data into an output message.

Server takes the reconstructed text, along with metadata such as user ID, information ID, and profile type, as input to an output formatter. Server constructs a response object containing at least the reconstructed text and may include fields indicating processing parameters or content type. The input of this step is the reconstructed information data and associated metadata, and the output is a structured response payload ready for transmission to the terminal.

### Step 20

Server transmits the output message to the terminal.

Server uses the response payload as input and sends it to the terminal via a communication interface using a response protocol. Server may compress the payload or apply other optimizations to reduce transmission size. The input of this step is the structured response object in server memory, and the output is a network response carrying reconstructed information data to the terminal.

### Step 21

Terminal receives and parses the output message.

Terminal takes the network response from the server as input and parses the response headers and body. Terminal extracts the reconstructed text and any metadata from the payload. The input of this step is the raw network response, and the output is reconstructed information data stored in terminal memory for display.

### Step 22

Terminal displays reconstructed information data to the user.

Terminal takes the reconstructed text and metadata as input and renders them in the user interface, for example as formatted paragraphs, bullet lists, or sectioned content. Terminal may highlight key points or annotate sections based on metadata such as information type. The input of this step is the parsed reconstructed information data, and the output is a visual representation on the terminal display that the user can read and interact with.

### Step 23

User reviews the reconstructed information and optionally issues additional requests.

User views the displayed content on the terminal as input to their decision-making and may judge that more detail, less detail, or a different style is needed. User may interact with interface elements such as buttons or input fields labeled “show more detail,” “simplify,” or “explain for a novice.” The input of this step is the displayed reconstructed information and UI controls, and the output is new user commands or additional text instructions captured by the terminal.

### Step 24

Terminal sends refinement requests to the server.

Terminal converts user commands or additional text instructions into a refinement request, taking the content identifier and possibly the current reconstructed text as input. Terminal includes an indication of the requested transformation, such as “detail,” “summarize,” or “change expression format,” and sends this refinement request to the server. The input of this step is the user's refinement actions and current content context, and the output is a new network request that triggers further prompt generation and reconstruction on the server.

### Step 25

Server updates prompt sentences based on refinement requests.

Server receives the refinement request as input and examines existing extraction result data and reconstructed information data associated with the original request. Server modifies or regenerates at least one prompt sentence to reflect the refinement operation, for example by adding instructions such as “make the following explanation 50% shorter” or “add more concrete examples while preserving technical accuracy.” The input of this step is the refinement request, user attributes, and stored intermediate data, and the output is updated prompt sentences and configuration values that will be used in subsequent tokenization and inference cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented news delivery systems typically apply static filtering or simple keyword-based personalization that does not fully exploit advanced machine learning capabilities. In such systems, server-side components often treat natural language content as opaque text and perform limited rule-based customization, which results in several technical problems within the computing environment.

First, conventional systems lack an integrated mechanism for dynamically adapting the generated text itself, including its difficulty level, information density, and linguistic style, to heterogeneous user attributes such as expertise level, reading ability, and domain-specific interests. As a consequence, a processor must store and transmit either multiple pre-authored variants of the same content or excessive volumes of raw content, thereby increasing storage usage, network bandwidth, and processing overhead across the computing infrastructure.

Second, existing architectures generally do not incorporate user emotion information as a real-time control signal in the content generation pipeline. Emotion signals, when present, are often treated as auxiliary metadata for recommendation ranking only, and are not fed back into the text generation or rewriting process. This results in under-utilization of captured user interaction data and prevents the system from adjusting tone and narrative structure at generation time. From a system perspective, this leads to a suboptimal use of computing resources in generative models, because the models operate without fine-grained conditioning, often generating unnecessarily long or unsuitable outputs that require post-processing or re-generation.

Third, emotion analysis, user profiling, and generative model invocation are frequently implemented as loosely coupled modules with separate data schemas and asynchronous workflows. This fragmentation introduces latency, redundant computations, and repeated serialization/deserialization of large text objects in memory. The processor may repeatedly analyze the same content for different users or different sessions, increasing CPU usage and main memory consumption, and degrading system throughput when handling many concurrent users.

Fourth, conventional systems do not maintain a closed feedback loop in which user interaction signals (such as comments, voice reactions, or operation events) are systematically ingested to update both user attribute information and user emotion information, and then immediately reflected in subsequent prompt construction for a generative AI model. Without such a feedback loop, the system fails to learn and refine user-specific presentation parameters at the server level, resulting in repeated generation of suboptimal content and inefficient utilization of network and processor resources.

Accordingly, there is a need for a computer-implemented system that tightly integrates: (i) server-side natural language processing of news information, (ii) unified management of user attribute information and user emotion information, (iii) generation of structured prompt sentences for a generative AI model, and (iv) dynamic tone and difficulty control at generation time. By doing so, the system can reduce redundant processing, lower the volume of transmitted data, and improve the responsiveness and relevance of generated content, thereby achieving a concrete improvement in the functioning of the computer system itself rather than merely providing a different presentation of information.

The specific processing by the specific processing unit 290 of the data processing device 12 in Application Example 2 is realized by the following means.

The present invention provides a server comprising a processor configured to acquire news information from an information source, analyze the acquired news information by a natural language processing operation to extract linguistic information and topic information, obtain user attribute information and user emotion information from a storage device based on user identification information, generate a prompt sentence for a generative AI model based on the user attribute information, the user emotion information, the news information, and the linguistic information, the prompt sentence instructing the generative AI model to execute summarization or rewriting of the news information, input the prompt sentence into the generative AI model to cause the generative AI model to generate a news information text having a difficulty level and content corresponding to the user attribute information and having a tone corresponding to the user emotion information, transmit the generated news information text to a user terminal, and acquire comment information, voice information, or operation information from the user through the user terminal and update the user emotion information and the user attribute information based on the acquired information. This enables the server to operate as a unified control entity that minimizes redundant text processing, dynamically adapts the behavior of the generative AI model using up-to-date user attribute and emotion states, and outputs news information texts that are computationally optimized in length, style, and tone for each user session, thereby improving overall processor utilization, memory efficiency, and network bandwidth efficiency in the news delivery system.

The term “news information” refers to electronic data representing textual content of reports, articles, or announcements concerning events or topics, the data being obtained from a network-accessible information source and processed by the system as an input for analysis and generation.

The term “information source” refers to a data-providing component, such as a network service, an application interface, or a data feed, that supplies news information in a structured or unstructured format to the server.

The term “natural language processing” refers to a computational procedure in which a processor analyzes human language text to derive linguistic information, including at least one of tokenization, part-of-speech tagging, syntactic parsing, named entity recognition, or keyword extraction.

The term “linguistic information” refers to structured data derived from natural language processing of news information, including at least tokens, parts of speech, syntactic structures, named entities, or extracted keywords that represent semantic or grammatical characteristics of the text.

The term “topic information” refers to data indicating one or more subjects, themes, or categories associated with the news information, the data being derived from the content of the news information using natural language processing or classification techniques.

The term “user identification information” refers to data that uniquely or quasi-uniquely identifies a user within the system, such as a user identifier, an account identifier, or a session identifier, and that is used to access corresponding user attribute information and user emotion information.

The term “user attribute information” refers to profile data associated with a user, including at least one of preference information, interest information, expertise level information, reading ability information, or domain-specific characteristic information, which are used to control generation of news information text.

The term “user emotion information” refers to data representing an emotional state of a user, including at least one of joy, anger, sadness, fear, or neutrality, and optionally including intensity values, the data being used to control tone or style of generated news information text.

The term “storage device” refers to a hardware component or logical storage resource, such as a memory device, a disk drive, or a database system, configured to store news information, user attribute information, user emotion information, or intermediate processing results.

The term “prompt sentence” refers to a textual instruction sequence provided as input to a generative AI model, the textual instruction sequence specifying a processing task, constraints, target audience characteristics, or tone settings for generation or rewriting of news information text.

The term “generative AI model” refers to a machine-learned computational model configured to generate or rewrite natural language text in response to an input prompt sentence, the model being trained on language data and executable by a processor or an external computing service.

The term “summarization” refers to a processing operation in which the generative AI model produces a condensed version of news information that preserves essential content while reducing length or complexity according to constraints defined in a prompt sentence.

The term “rewriting” refers to a processing operation in which the generative AI model generates alternative textual content that conveys at least part of the meaning of input news information while modifying at least one of style, structure, difficulty level, or tone according to a prompt sentence.

The term “news information text” refers to natural language text generated or rewritten by the generative AI model based on news information and a prompt sentence, the text being adapted in at least difficulty level, content selection, or tone for presentation to a user.

The term “difficulty level” refers to a property of news information text indicating complexity of vocabulary, sentence structure, or amount of technical detail, the property being adjusted to correspond to user attribute information such as expertise level or reading ability.

The term “tone” refers to an expressive characteristic of news information text, including at least positive, neutral, critical, or problem-raising styles, the expressive characteristic being controlled based on user emotion information or an estimated emotion state.

The term “user terminal” refers to an end-user device, such as a mobile terminal, a personal computing device, or a client apparatus, configured to communicate with the server, present news information text to the user, and transmit user interaction information to the server.

The term “comment information” refers to user-provided textual data entered via the user terminal in response to presented news information text, the textual data being used for emotion analysis or updating of user attribute information.

The term “voice information” refers to audio data representing a user's spoken reaction or utterance captured via the user terminal, the audio data being optionally converted to text and used for emotion analysis or updating of user attribute information.

The term “operation information” refers to data representing user interactions with a user interface on the user terminal, including at least selection operations, rating operations, or navigation operations, the data being used to update user attribute information or user emotion information.

The term “browsing history information” refers to data indicating a record of news information texts accessed or viewed by the user, including at least identifiers and timestamps, the data being used to determine a presentation order or to refine personalization.

The term “presentation order” refers to an arrangement sequence in which a plurality of news information texts are output to the user terminal, the arrangement sequence being determined based at least on user emotion information or browsing history information.

The term “news feed” refers to a structured sequence or collection of news information texts prepared for presentation to the user, the sequence or collection being personalized with respect to content selection, presentation order, or text characteristics.

The term “emotion analysis unit” refers to a functional component implemented in software, hardware, or a combination thereof, which receives comment information or voice information and outputs user emotion information or an estimated emotion state by applying an emotion recognition algorithm.

The term “emotion state” refers to a representation of a user's current or recent emotional condition inferred by the emotion analysis unit, including at least an emotion category and optionally an intensity value, the representation being used for control of the prompt sentence.

The term “server” refers to a computing apparatus or computing system including the processor and the storage device, configured to perform acquisition, analysis, generation, transmission, and updating operations associated with news information and user information in the system.

In one embodiment, a server implements the claimed system as a network-accessible computing apparatus that cooperates with one or more user terminals. The server includes at least one hardware processor, a main memory, a non-transitory storage device, and a network interface. The server executes a program composed of multiple software modules, including a news acquisition module, a natural language processing module, a user profile management module, a prompt generation module, a generative AI interface module, an emotion analysis module, and a feed personalization module. The server may be implemented on a physical machine or a virtualized environment in a data center or cloud platform.

The server uses general-purpose server hardware, such as a central processing unit, a system memory, and a network controller, and executes an operating system and application software written in a programming language, such as a high-level scripting language. The server stores news information, user attribute information, user emotion information, and intermediate processing results in a storage device such as a relational database system or a key-value store.

The server obtains news information from an information source via the network interface. The server may access one or more news APIs or content feeds, and receives news information in a structured format, such as a markup document or structured text. The server stores the raw news information and associated metadata, such as title, timestamp, source identifier, and topic tags, in a database table having fields for article identifier, textual content, and pre-processing status. By normalizing the storage of news information into such a fixed schema, the server reduces the amount of redundant data loading and simplifies subsequent indexing operations, which leads to improved input/output performance.

The server performs natural language processing on the stored news information. The server applies a natural language processing library, such as a syntactic and semantic analysis framework, to parse the news information and generate linguistic information and topic information. The linguistic information includes token sequences, part-of-speech tags, named entity labels, dependency relations, and sentence boundaries. The topic information includes topic vectors or category labels derived from the news information content, obtained by applying topic modeling or classification algorithms, such as a probabilistic topic model or a neural text classifier. The server stores the linguistic information and the topic information in structured fields linked to each article identifier. This structured representation allows the server to avoid re-parsing the same content for different users and sessions, thereby reducing processor time and memory usage.

The server manages user attribute information and user emotion information in a user profile storage. The server stores, for each user identifier, information such as user occupation, interest categories, preferred reading difficulty, typical engagement duration, and historical emotion patterns. The server may represent this information as a compact feature vector, in which each dimension corresponds to a normalized attribute. For example, the server may encode reading level as a discrete scalar and interests as a multi-hot vector across topic categories. The server updates these representations when new interactions are recorded, reducing the need to recompute user attributes from raw logs and thereby improving update efficiency.

The server also maintains user emotion information, which represents an estimated current emotion state for each user. The server derives this information from comment information, voice information, and operation information obtained from the user via the user terminal. The server may store an emotion categorical label (such as joy, anger, or neutral) and a continuous intensity score. The server uses this information as a conditioning input to control the tone of generated news information text.

The terminal operates as a client device that provides a user interface and input/output capabilities. The terminal may be a smartphone, a tablet, a personal computer, or another computing device. The terminal executes an application that communicates with the server via a network protocol. The terminal downloads news information text from the server and presents it in a graphical user interface, along with controls for scrolling, selecting, and reacting to content. The terminal captures user input, including comment information, voice information, and operation information (such as clicks, taps, and scroll events), and transmits these data to the server with a user identifier, an article identifier, and a timestamp.

The user interacts with the terminal to view the personalized news feed. The user reads the generated news information text, selects items of interest, and optionally provides feedback, such as textual comments (“This article is very helpful”), spoken reactions, or selection of reaction icons. The user behavior produces a continuous stream of interaction data that the terminal transmits to the server. The server analyzes these data to update user attribute information and user emotion information.

The server implements an emotion analysis module configured to estimate user emotion information from comment information and voice information. The server may first convert voice information into text using a speech recognition engine, and then apply a text-based emotion classification algorithm. In one embodiment, the server employs a neural network model configured as a transformer-based classifier, having multiple attention layers, feed-forward layers, and a softmax output layer that produces probabilities for emotion categories. The server uses linguistic features such as token embeddings, sentence position embeddings, and context-aware representation vectors as input to this classifier. The classifier is trained using supervised learning on labeled emotion data, with a loss function such as cross-entropy and an optimization method such as gradient-based optimization. The server updates the model parameters by iteratively computing prediction errors over training samples, backpropagating the errors through the network, and updating the weights according to a learning rate schedule.

The server also implements a generative AI model interface module that interacts with a generative AI model. The generative AI model may be a neural sequence-to-sequence language model with an encoder-decoder architecture using multiple attention layers, or a decoder-only transformer language model. The server either executes the generative AI model locally on a processor with a specialized accelerator or accesses the generative AI model via a network-based inference service. The generative AI model is trained on a large corpus of text data using an objective such as next-token prediction or masked-token prediction. During training, the model minimizes a loss function that measures the difference between predicted tokens and actual tokens, and updates its weight parameters through gradient-based optimization. The server stores the trained model parameters in a model storage and loads them into memory for inference.

The server uses the linguistic information, topic information, user attribute information, and user emotion information to generate a prompt sentence for the generative AI model. The server constructs the prompt sentence as a structured text sequence that includes explicit instructions, constraints, and contextual text. The server decides which fields to include in the prompt sentence based on the user's attributes and the target output. For example, the server can set constraints on output length, vocabulary complexity, emphasis on certain topics, and desired tone. The server may encode each of these factors as clauses within the prompt sentence so that the generative AI model can use them as conditioning context.

In one example, when the user is a medical professional with an expert reading level and the user emotion information is neutral, the server constructs the following prompt sentence:

“You are a generative AI model that rewrites news articles. Summarize the following article for a medical professional at an expert level. Use technical medical terminology and focus on mechanisms of action, trial design, efficacy rates, and adverse events. Article text: [ARTICLE_TEXT]”

In another example, when the user is a general user with a beginner reading level and the user emotion information indicates joy, the server constructs the following prompt sentence:

“You are a generative AI model that personalizes news. Rewrite the following article in simple English for a general user with beginner knowledge. The user currently feels joy, so use a positive and hopeful tone while remaining accurate. Focus on the main points only. Article text: [ARTICLE_TEXT]”

In yet another example, when the user emotion information indicates anger, the server constructs the following prompt sentence:

“You are a generative AI model that adjusts tone. The user currently feels anger. Rewrite the following news article in a problem-raising and critical tone. Highlight issues, conflicts, and open problems, but do not invent facts. Original article: [ARTICLE_TEXT]”

The server inputs the prompt sentence and the article text into the generative AI model. The generative AI model processes the input sequence token by token, computing attention scores and hidden states across its layers. The model outputs a generated token sequence representing the news information text. Because the prompt sentence explicitly encodes user attribute information and user emotion information, the generative AI model generates a news information text that has a difficulty level and content adapted to the user, and a tone aligned with the user's emotion state. The server may apply decoding strategies, such as beam search or top-k sampling, to reduce repetition and maintain fluency. The server may further apply a length penalty or a stop condition to avoid overly long outputs, resulting in reduced bandwidth requirements for transmission to the terminal.

The server stores the generated news information text together with metadata, such as difficulty level, tone category, and generation timestamp. The server associates this data with the corresponding article identifier and user identifier. The server transmits the generated news information text to the user terminal via the network interface. By generating and transmitting only a single tailored version for each user, rather than multiple preset variants, the server reduces the amount of content that must be stored and transmitted, thereby decreasing storage usage and network load.

The server implements a feed personalization module that determines the presentation order of generated news information text. The server calculates a ranking score for each candidate article using features such as topic similarity to user interests, recency of the article, user browsing history, and user emotion information. For example, the server may increase the score of articles with topics that the user has frequently engaged with and adjust scores based on whether the tone of the generated text is likely to match the user's current emotion state. The server computes these scores using a trained ranking function, such as a gradient-boosted decision tree model or a neural ranking model. The server then sorts the articles according to the scores and constructs a personalized news feed.

The server outputs the personalized news feed to the terminal in the determined presentation order. The terminal displays the feed with headlines and corresponding news information text. Because the server precomputes linguistic information, user feature vectors, and candidate ranking features, the feed can be generated and delivered with reduced latency compared to systems that compute these operations at request time. This improves the responsiveness of the system from the user's perspective and increases the throughput of the server.

The server continuously updates user attribute information and user emotion information based on incoming interaction data. When the user reacts to a presented news information text with a comment such as “This is too technical” or “This summary is easy to understand”, the server analyzes the comment through the emotion analysis module and optionally a comprehension-level classifier. The server adjusts the user's preferred difficulty level accordingly, for example by lowering the difficulty level parameter in the profile when negative feedback about complexity is detected. The server then changes the structure of subsequent prompt sentences to request simpler language or shorter sentences. This closed feedback loop allows the system to refine its behavior over time and reduces the need for manual configuration of user preferences.

The server improves computer technology in several ways. By precomputing and storing linguistic information and topic information in structured forms, the server avoids repeated parsing operations, thereby decreasing CPU cycles and energy consumption. By encoding user attributes and emotion states as compact feature vectors, the server enables efficient in-memory computations for recommendation and prompt generation, reducing memory footprint. By controlling the generative AI model via precise prompt sentences that specify length, tone, and difficulty, the server minimizes the generation of extraneous tokens and avoids the need to generate and then discard large amounts of text, which leads to improved inference efficiency and lower network traffic. The server's integration of emotion analysis and generative control also reduces the number of regeneration cycles required to obtain satisfactory outputs, thereby improving end-to-end processing speed.

The server uses model architectures and training methods that are not merely automation of human editorial work, but that exploit machine-readable feature structures and mathematical optimization procedures that cannot be performed manually at scale. The generative AI model and emotion analysis model rely on high-dimensional parameter spaces and optimization algorithms; they use internal representations, such as context vectors and attention matrices, that reflect statistical dependencies across large corpora of text. The server uses these representations in combination with explicit prompt structures and user feature vectors to achieve transformation and generation patterns that are not achievable with simple rule-based or manual selection processes. This non-conventional combination of structured prompt generation, feature-based ranking, and neural text generation changes the way the computer processes and routes textual data, thereby improving computational efficiency and system performance.

In another embodiment, the server uses an alternative neural network architecture, such as a recurrent neural network with attention mechanisms or a convolutional sequence model, instead of a transformer-based model. In such a case, the server still uses prompt sentences as conditioning input, and the network processes the prompt tokens followed by the article tokens to generate output text. The training procedure may use similar objectives and error functions. The system behavior remains within the scope of the claimed invention as long as the server generates prompt sentences based on user attribute information and user emotion information, and uses a generative AI model to produce personalized news information text.

In still another embodiment, the terminal performs part of the emotion analysis locally, for example by running a lightweight classifier model to determine coarse emotion labels and transmitting only the labels and confidence scores to the server. The server then uses these labels as user emotion information in the prompt generation process. This division of labor can further reduce network bandwidth requirements for transmitting raw voice or text data and can improve privacy by limiting the amount of data sent to the server.

In yet another embodiment, the server stores multiple generative AI models specialized for different domains, such as medical news, financial news, or environmental news. The server selects a specific model based on topic information or user interests. The server still controls each selected model through prompt sentences that encode user attribute information and user emotion information. This configuration allows the server to improve accuracy and relevance in each domain while maintaining the same overall system architecture.

Through these embodiments, the server, the terminal, and the user cooperatively implement the claimed system, in which prompt sentence construction, generative AI model control, and emotion-aware personalization are executed as concrete technical operations within the computing infrastructure. The described data structures, model architectures, and processing flows provide a reproducible and concrete way to implement the invention so that others skilled in the art can make and use the system.

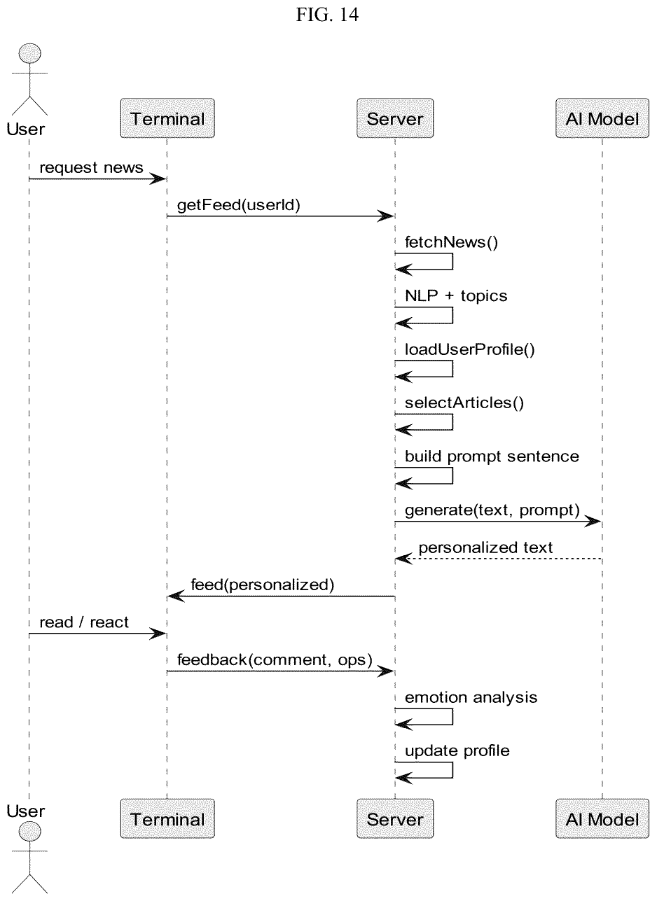

The following describes the processing flow using FIG. 14.

### Step 1

Server acquires raw news information from one or more information sources.

Server receives, as input, access parameters such as an API endpoint, feed URL, or query condition, and sends a network request via a network interface. Based on the response, server performs data parsing to extract fields such as title, body text, publication time, and source identifier, and outputs structured news records. Server stores each news record in a storage device with an internal article identifier, so that later modules can reference the content without re-fetching it.

### Step 2

Server performs natural language processing on the stored news information.

Server takes, as input, the body text and metadata of each article from the storage device, and applies linguistic analysis using a natural language processing library. Server executes tokenization, part-of-speech tagging, sentence segmentation, named entity recognition, and topic classification. From these operations, server performs data transformation that converts raw text into linguistic information (token lists, tags, entities) and topic information (topic labels, topic vectors) and outputs these as structured feature sets. Server writes the feature sets back to the storage device, linked to the corresponding article identifiers.

### Step 3

Server retrieves user attribute information and user emotion information.

Server receives, as input, a user identifier from a request sent by terminal. Using this identifier, server executes a database query to fetch profile fields such as occupation, interest categories, preferred reading difficulty, and past emotion states. Server performs feature vector construction, in which server encodes these fields into a normalized internal representation, and outputs a user attribute vector and a user emotion vector. Server retains these vectors in working memory for subsequent processing.

### Step 4

Terminal presents news content candidates and collects user interaction signals.

Terminal receives, as input, a list of candidate article identifiers and associated basic metadata from server. Terminal displays headlines or simple previews and waits for user actions. User selects an item to read, scrolls, or closes the view, and may enter comment information or produce voice information via a microphone. Terminal performs event logging, converting these user actions into operation information including event type, timestamps, and related article identifiers, and outputs a structured interaction payload that terminal transmits to server.

### Step 5

Server acquires interaction payloads and updates browsing history information.

Server receives, as input, the interaction payload sent from terminal, including article identifiers, event types, and timestamps. Server performs data aggregation, where server appends these events to a browsing history table and updates per-user statistics such as read count per topic and average dwell time. Server outputs updated browsing history information and engagement metrics linked to the user identifier, which are stored in the storage device for later use in personalization.

### Step 6

Server performs emotion analysis based on comment information and voice information.

Server receives, as input, comment information and, when available, text converted from voice information, together with associated user and article identifiers. Server applies an emotion analysis algorithm, typically a trained neural network classifier, to the textual content. Server performs feature extraction by converting tokens into embeddings, runs the classifier to compute emotion category probabilities, and selects the highest-probability category and its intensity as the estimated emotion state. Server outputs updated user emotion information, which server stores in the user profile and also keeps in temporary memory for immediate use in subsequent steps.

### Step 7

Server determines candidate news articles for personalization.

Server receives, as input, the user attribute vector, the updated user emotion vector, and a set of available news records with their topic information. Server performs relevance scoring, computing a similarity measure between user interests and article topics, and filters out articles that appear in the user's recent browsing history. Server applies a ranking algorithm that combines topic match, recency, and engagement likelihood into a numerical score. Server outputs a ranked list of candidate article identifiers and their associated features for personalized generation.

### Step 8

Server constructs a prompt sentence for each selected article.

Server receives, as input, the article text, the linguistic information and topic information for that article, and the user attribute vector and user emotion vector. Server performs rule-based prompt assembly, inserting parameterized clauses that specify audience type, desired difficulty level, target length, and tone control. For example, server may generate a prompt sentence such as:

“You are a generative AI model that personalizes news. Rewrite the following article in simple English for a general user with beginner knowledge. The user currently feels joy, so use a positive and hopeful tone while remaining accurate. Focus on the main points only. Article text: [ARTICLE_TEXT]”

Server outputs a prompt sentence string for each target article, and logs the mapping from user identifier and article identifier to the generated prompt sentence.

### Step 9

Server invokes the generative AI model to generate personalized news information text.

Server receives, as input, the prompt sentence and, if required, the article text concatenated to the prompt. Server passes this input sequence to a generative AI model, which may be a trained neural language model accessible locally or via a network service. The model performs internal numerical computations such as attention-weight calculation and hidden state propagation. From the server's perspective, server performs inference control: server sets generation parameters such as maximum token count, temperature, or sampling strategy, then receives a generated token sequence as output. Server converts the token sequence into natural language text and outputs a personalized news information text that conforms to the constraints defined in the prompt sentence.

### Step 10

Server performs optional post-processing and tone verification of generated text.

Server receives, as input, the personalized news information text and the current user emotion information. Server executes text analysis routines to measure length, lexical difficulty, and sentiment polarity. Based on this analysis, server determines whether the generated text satisfies predefined thresholds, such as maximum length or tone alignment with the user's emotion state. If the output violates constraints, server may slightly adjust the prompt sentence and request a regeneration, or apply lightweight text trimming or rephrasing rules. Server outputs a validated and, if necessary, corrected news information text for delivery to terminal.

### Step 11

Server personalizes the presentation order of multiple generated texts.

Server receives, as input, multiple validated personalized news information texts, their corresponding article identifiers, their ranking scores, and the updated browsing history information. Server executes a ranking refinement algorithm that adjusts the initial scores based on diversity constraints, recency penalties, and emotion-aware priorities. For example, server may prioritize positive-tone items when the emotion state suggests preference for encouraging content. Server performs sorting based on the refined scores and outputs an ordered list of news items, each associated with the corresponding personalized news information text.

### Step 12

Server transmits the personalized news feed to the terminal.

Server receives, as input, the ordered list of news items and the user identifier. Server performs data packaging, assembling for each item the article identifier, title, personalized news information text, and any auxiliary display metadata. Server transmits this packaged data as a response message to terminal over a network connection and outputs an acknowledgment that the feed has been dispatched for the current user session.

### Step 13

Terminal renders the personalized news feed and collects new feedback.

Terminal receives, as input, the personalized news feed from server, including the ordered items and associated personalized news information text. Terminal performs layout and rendering operations, presenting each item with its title and generated text in the user interface. User reads the items, scrolls through the feed, and may select individual articles for more detail or provide reactions. Terminal converts these actions into new operation information, comment information, or voice information and outputs updated interaction payloads that are transmitted back to server, thereby closing the feedback loop for the next cycle of personalization.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

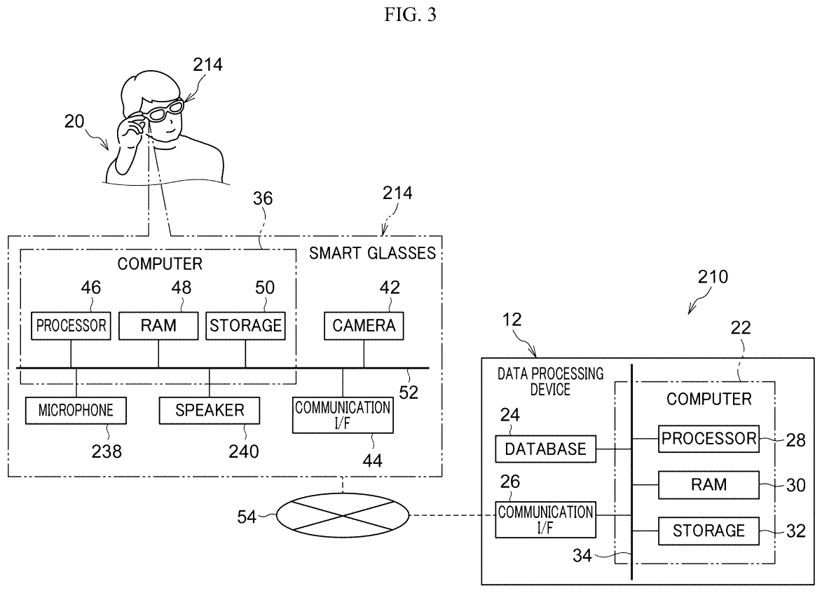

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

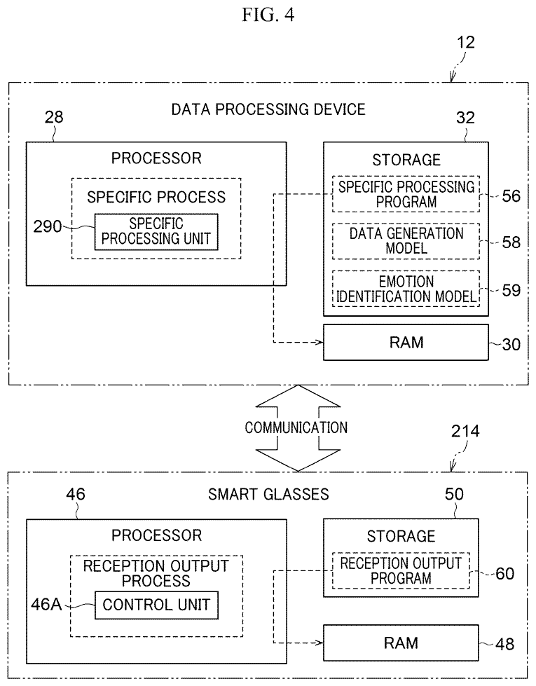

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

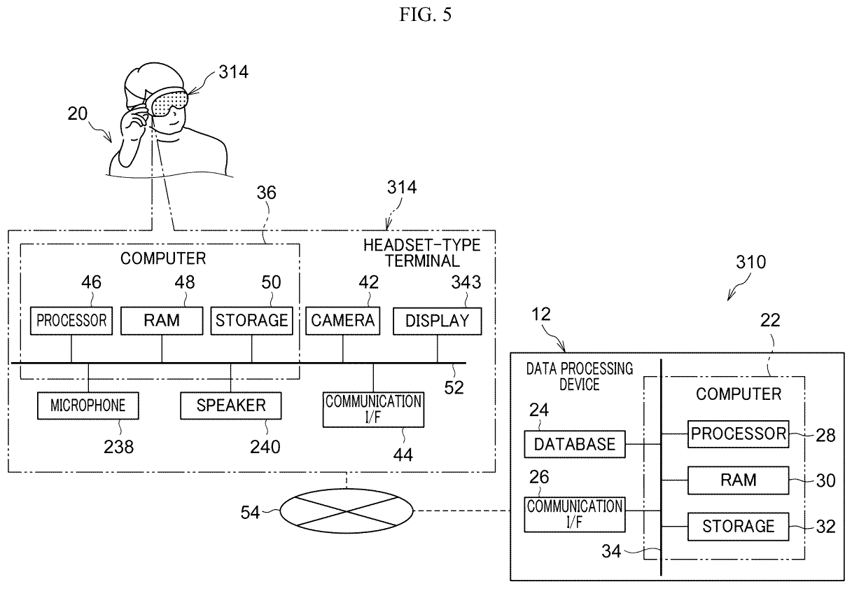

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

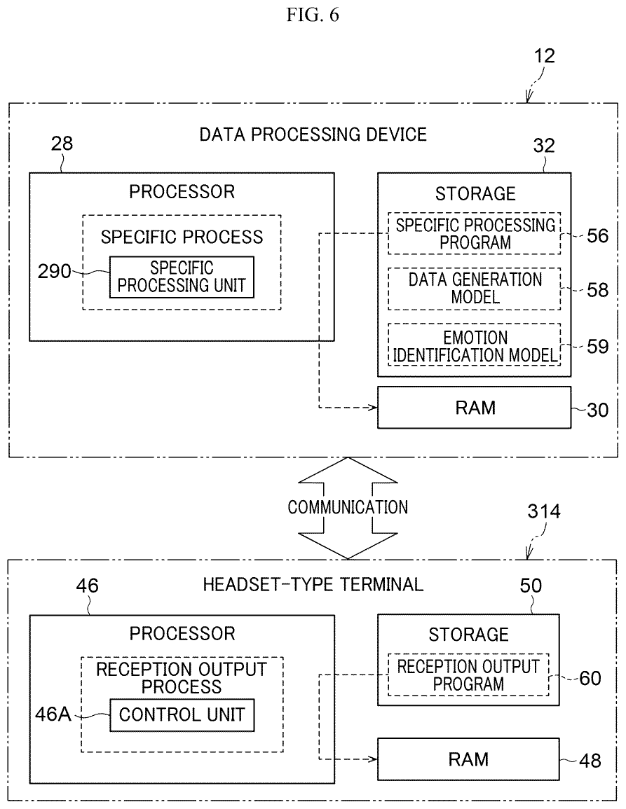

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

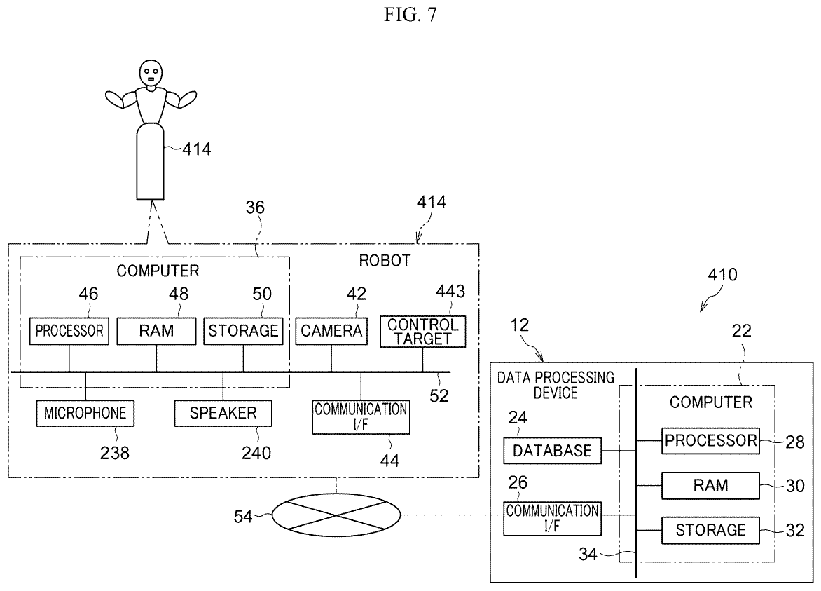

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

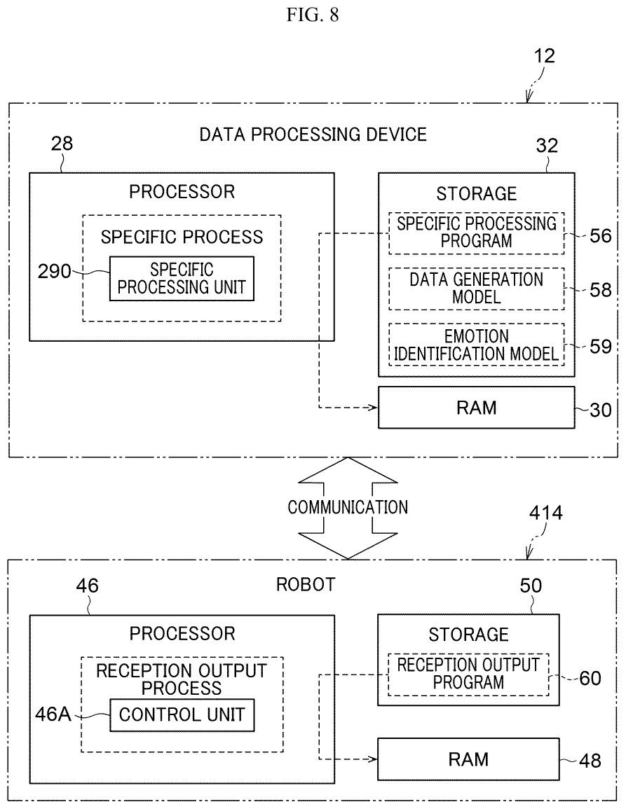

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

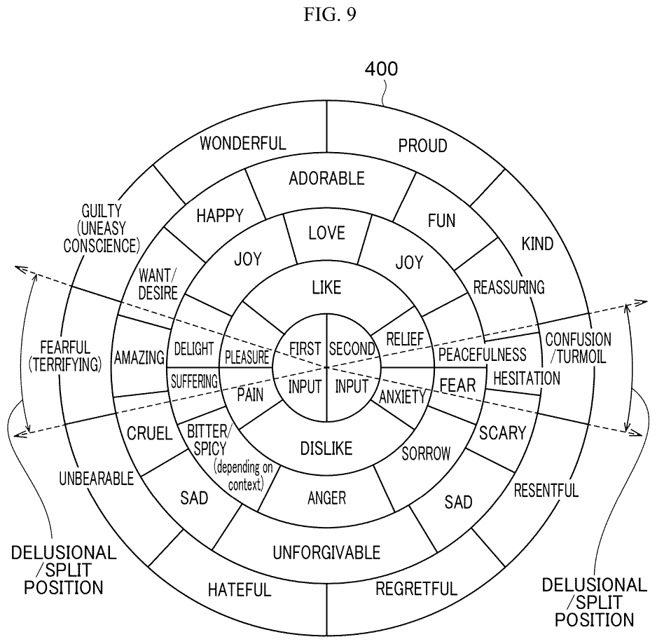

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

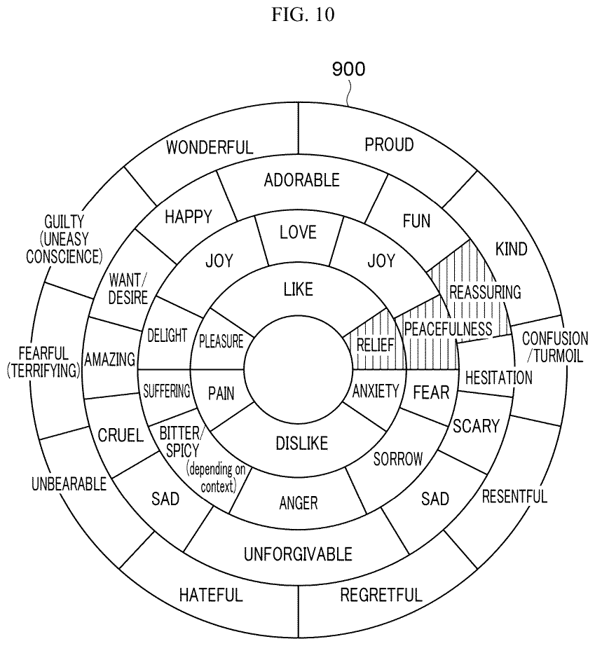

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, by a communication unit, identification information of an external information source and user characteristic information, and to obtain document information via a network based on the identification information,
analyze the document information by using a natural language processing program to segment the document information into syntactic units, assign part-of-speech information and phrase information to the syntactic units, calculate importance scores based on degrees of relevance among the syntactic units, and extract important syntactic units and phrases,
generate a prompt sentence including instruction information that contains the user characteristic information and context information that contains the extracted syntactic units and phrases, and provide the prompt sentence to a generative information processing model so as to cause the generative information processing model to generate summary information corresponding to the user characteristic information,
adjust, based on user emotional state information and the user characteristic information, at least one of the prompt sentence to be input to the generative information processing model and an expression format of the generated summary information, and generate reconstructed information having a tone and a level of detail corresponding to the user emotional state, and
output the reconstructed information to a user terminal via a display device or a message delivery device.

### Supplementary 2

The system according to supplementary 1,
wherein the processor is configured to
analyze circulation-type information and information distributed in a standardized description format as the document information, apply a document summarization algorithm to the document information to calculate the importance scores, and provide, as the context information to the generative information processing model, the syntactic units and phrases extracted by the document summarization algorithm.

### Supplementary 3

The system according to supplementary 1,
wherein the processor is configured to
generate electronic mail transmission information by using a communication unit, and transmit, as electronic mail including the reconstructed information, the reconstructed information to the user terminal.

### Application Example 1

### Supplementary 1

A system comprising a processor,
wherein the processor is configured to
obtain article information from a network resource and store the article information as structured character information in a storage medium,
perform natural language processing on the article information to generate analysis information including phrase information, importance information, and event information,
select article information related to a user on the basis of the analysis information and user attribute information including interest information, knowledge level information, and reading ability information of the user, and perform weighting processing and ranking processing on the selected article information,
generate a prompt sentence to be input to a generative information processing model on the basis of the analysis information and the user attribute information, provide the prompt sentence to the generative information processing model, and cause the generative information processing model to generate summary information or rewritten information of the article information, and
associate the summary information or the rewritten information acquired from the generative information processing model with identification information and supplementary information of the article information to generate individualized information, and transmit the individualized information to a user information terminal.

### Supplementary 2

The system according to supplementary 1,
wherein the processor is configured to update the user attribute information on the basis of operation history information and evaluation information transmitted from the user information terminal, and to sequentially re-execute the selecting of the article information, the generating of the prompt sentence, and the generating of the individualized information by using the updated user attribute information.

### Supplementary 3

The system according to supplementary 1,
wherein the processor is configured to include, in the prompt sentence provided to the generative information processing model, interest field information, knowledge level information, text length constraint information, and explanation style information based on the user attribute information, and thereby control a vocabulary level, an amount of text, and a content focus of the summary information or the rewritten information.

### Example 2

### Supplementary 1

A system comprising a processor,
wherein the processor is configured to
receive information as input,
acquire the information according to an acquisition source of the information and generate text data in a form from which main content can be extracted,
generate a first prompt sentence that instructs a generative AI model to analyze the text data and extract important content based on attribute information of a user, the first prompt sentence being generated using the text data and the attribute information of the user as inputs,
transmit the first prompt sentence and the text data to the generative AI model and obtain extraction result data from the generative AI model,
generate a second prompt sentence that instructs the generative AI model to reconstruct the extraction result data into an expression form adapted to the user based on the extraction result data and the attribute information of the user,
transmit the second prompt sentence and the extraction result data to the generative AI model and obtain reconstructed information data corresponding to the attribute information of the user from the generative AI model, and
generate the reconstructed information data as output data and transmit the output data to an external apparatus.

### Supplementary 2

The system according to supplementary 1,
wherein the processor is configured to
acquire state information relating to an emotional state of the user, and modify at least one prompt sentence provided to the generative AI model based on the state information so as to change a tone of the reconstructed information data in accordance with the emotional state.

### Supplementary 3

The system according to supplementary 1,
wherein the processor is configured to
sequentially change at least one prompt sentence provided to the generative AI model according to a type of the information, the attribute information of the user, and an additional request from the user, and re-instruct the generative AI model so as to perform at least one of detailing, summarizing, and changing an expression format of the reconstructed information data.

### Application Example 2

### Supplementary 1

A system comprising a processor,
wherein the processor is configured to
acquire news information from an information source,
analyze the acquired news information by natural language processing to extract linguistic information and topic information,
obtain, from a storage device, user attribute information and user emotion information based on user identification information,
generate a prompt sentence for a generative AI model based on the user attribute information, the user emotion information, the news information, and the linguistic information, the prompt sentence instructing the generative AI model to execute summarization or rewriting of the news information,
input the prompt sentence into the generative AI model to cause the generative AI model to generate a news information text having a difficulty level and content corresponding to the user attribute information and having a tone corresponding to the user emotion information, transmit the generated news information text to a user terminal, and
acquire comment information, voice information, or operation information from a user through the user terminal and update the user emotion information and the user attribute information based on the acquired information.

### Supplementary 2

The system according to supplementary 1,
wherein the processor is configured to
determine a presentation order of the generated news information text based on the user emotion information and browsing history information, and output, to the user terminal, a plurality of news information texts configured as an individual news feed in the determined presentation order.

### Supplementary 3

The system according to supplementary 1,
wherein the processor is configured to
input the comment information or the voice information acquired from the user into an emotion analysis unit to estimate an emotion state, and change contents of instructions in the prompt sentence based on the estimated emotion state so as to dynamically adjust a tone of the news information text generated by the generative AI model.

What is claimed is:

1. A system comprising:
circuitry configured to:
receive input data records via a communication interface coupled to a packet-switched network;
apply a natural language processing operation to the input data records to segment the input data records into syntactic unit data, assign part-of-speech tag data and phrase boundary data to the syntactic unit data, and compute relevance score values based on degrees of association among the syntactic unit data;
extract, based on the relevance score values, a subset of the syntactic unit data and associated phrase boundary data;
construct a parameterized instruction sequence that includes attribute parameter data associated with a recipient entity and context data derived from the extracted subset; and
provide the parameterized instruction sequence to a generative neural network model to cause the generative neural network model to generate structured output data corresponding to the attribute parameter data.

2. The system according to claim 1, wherein the circuitry is further configured to:
compute the relevance score values by constructing a vector representation of respective ones of the syntactic unit data using a term-frequency-inverse-document-frequency weighting, computing pairwise similarity values among the vector representations, and executing an iterative graph-based ranking algorithm over a graph structure in which nodes correspond to respective syntactic unit data and edge weights correspond to the pairwise similarity values.

3. The system according to claim 2, wherein the circuitry is further configured to:
select, from the syntactic unit data, syntactic units having relevance score values exceeding a threshold value or belonging to a top-rank subset, and aggregate token frequency statistics within the selected syntactic units to identify multi-token key phrases according to part-of-speech tag patterns.

4. The system according to claim 3, wherein the circuitry is further configured to:
filter the selected syntactic units and multi-token key phrases based on the attribute parameter data by comparing tokens and named entity labels in the selected syntactic units against a domain-specific vocabulary data structure stored in a memory, and retain syntactic units matching domain, topic, or expertise-level criteria indicated by the attribute parameter data.

5. The system according to claim 4, wherein the circuitry is further configured to:
obtain affective state classification data associated with the recipient entity, and modify the parameterized instruction sequence based on the affective state classification data to control a tone characteristic of the structured output data generated by the generative neural network model.

6. The system according to claim 5, wherein the affective state classification data comprises an arousal-level value and a valence-level value represented as numerical components of an affective state vector, and wherein the circuitry modifies the parameterized instruction sequence by inserting constraint language that specifies a reassuring tone when the valence-level value is below a first threshold or a concise neutral tone when the valence-level value is above a second threshold.

7. The system according to claim 6, wherein the generative neural network model comprises a transformer-based architecture including a plurality of self-attention layers, feed-forward layers, and normalization layers, and wherein the circuitry provides the parameterized instruction sequence as a token sequence to the transformer-based architecture to condition generation of the structured output data on the attribute parameter data and the affective state classification data.

8. The system according to claim 7, wherein the circuitry is further configured to:
set decoding control parameters including a maximum output token count, a sampling temperature value, and a nucleus sampling threshold value, and provide the decoding control parameters together with the parameterized instruction sequence to the generative neural network model to constrain generation of the structured output data.

9. The system according to claim 8, wherein the circuitry is further configured to:
adjust the sampling temperature value based on the affective state classification data such that a lower sampling temperature value is applied when the arousal-level value exceeds a stress threshold, thereby reducing lexical variability in the structured output data.

10. The system according to claim 5, wherein the circuitry is further configured to:
generate the structured output data as reconstructed information data having a difficulty level and a content focus corresponding to the attribute parameter data and a tone corresponding to the affective state classification data, and transmit the reconstructed information data to a terminal apparatus via the packet-switched network.

11. The system according to claim 10, wherein the input data records comprise document information obtained from an external information source accessible via the packet-switched network, and wherein the circuitry acquires the document information by transmitting retrieval request data to a network address associated with the external information source and parsing response data to extract body text fields, timestamp fields, and source identifier fields into normalized document records stored in a storage medium.

12. The system according to claim 11, wherein the circuitry is further configured to:
generate electronic mail transmission data including a destination address field derived from the attribute parameter data and a body field containing the reconstructed information data, and transmit the electronic mail transmission data via a mail transfer protocol to the terminal apparatus.

13. The system according to claim 10, wherein the circuitry is further configured to:
receive, from the terminal apparatus, interaction history data comprising selection event records, duration metrics, and evaluation signal records, and update the attribute parameter data based on the interaction history data by applying a weighted moving average to per-category relevance scores derived from the interaction history data.

14. The system according to claim 13, wherein the circuitry is further configured to:
re-execute the extraction based on updated relevance score values computed using the updated attribute parameter data, reconstruct the parameterized instruction sequence using the updated attribute parameter data, and cause the generative neural network model to generate updated structured output data reflecting the updated attribute parameter data.

15. The system according to claim 10, wherein the circuitry is further configured to:
construct a first parameterized instruction sequence that instructs the generative neural network model to extract important content from the input data records based on the attribute parameter data and obtain extraction result data from the generative neural network model, and construct a second parameterized instruction sequence that instructs the generative neural network model to reconstruct the extraction result data into an expression form adapted to the recipient entity based on the attribute parameter data.

16. The system according to claim 15, wherein the circuitry is further configured to:
cache the extraction result data in an intermediate data store associated with an identifier of the input data records, and reuse the cached extraction result data for generating a plurality of distinct reconstructed information data outputs corresponding to different attribute parameter data without re-executing the extraction.

17. The system according to claim 10, wherein the circuitry is further configured to:
determine a presentation ordering of a plurality of the structured output data based on the affective state classification data and browsing history information data, and transmit the plurality of the structured output data to the terminal apparatus in the determined presentation ordering as a personalized feed data structure.

18. A system comprising:
circuitry configured to:
receive, via a communication interface coupled to a packet-switched network, input data records from an external information source;
execute a natural language processing program to segment body text of the input data records into syntactic unit data, assign part-of-speech tag data to tokens within the syntactic unit data, and compute relevance score values by constructing a term-weight matrix and executing an iterative graph-based ranking algorithm over a graph structure in which nodes represent respective syntactic unit data;
extract a subset of the syntactic unit data having relevance score values exceeding a selection threshold;
obtain attribute parameter data and affective state classification data associated with a recipient entity from a storage medium;
construct a parameterized instruction sequence incorporating the attribute parameter data, the affective state classification data, and context data derived from the extracted subset;
provide the parameterized instruction sequence to a generative neural network model having a transformer-based architecture including a plurality of self-attention layers to cause the generative neural network model to generate structured output data having a content focus and difficulty level corresponding to the attribute parameter data and a tone corresponding to the affective state classification data; and
transmit the structured output data to a terminal apparatus via the packet-switched network.

19. The system according to claim 18, wherein the circuitry is further configured to:
receive, from the terminal apparatus, at least one of comment data, voice data converted to text, or operation event data, input the received data into an emotion classification model implemented as a neural network classifier to estimate an updated affective state classification, and modify the parameterized instruction sequence based on the updated affective state classification for subsequent generation by the generative neural network model.

20. A method performed by circuitry, the method comprising:
receiving input data records via a communication interface coupled to a packet-switched network;
applying a natural language processing operation to the input data records to segment the input data records into syntactic unit data, assign part-of-speech tag data and phrase boundary data to the syntactic unit data, and compute relevance score values based on degrees of association among the syntactic unit data;
extracting, based on the relevance score values, a subset of the syntactic unit data and associated phrase boundary data;
constructing a parameterized instruction sequence that includes attribute parameter data associated with a recipient entity and context data derived from the extracted subset; and
providing the parameterized instruction sequence to a generative neural network model to cause the generative neural network model to generate structured output data corresponding to the attribute parameter data.
